(19) United States
(12) Patent Application Publication
(10) Pub. No.: US 2025/0145852 A1
(43) Pub. Date: May 8, 2025

(54) DURABLE OMNIPHOBIC ELASTOMERIC COATINGS AND METHODS FOR PREPARING THE SAME

(71) Applicant: The Regents of The University of Michigan, Ann Arbor, MI (US)

(72) Inventors: Anish TUTEJA, Ann Arbor, MI (US); Jing WANG, Ann Arbor, MI (US); Neil P. DASGUPTA, Ann Arbor, MI (US)

(73) Assignee: The Regents of The University of Michigan, Ann Arbor, MI (US)

(21) Appl. No.: 18/837,286

(22) PCT Filed: Feb. 10, 2023
(86) PCT No.: PCT/US2023/012794

§ 371 Date: Aug. 9, 2024

Related U.S. Application Data
(60) Provisional application No. 63/309,309, filed on Feb. 11, 2022.

(51) Int. Cl. C09D 175/04; C08G 18/08; C08G 18/10; C08G 18/24; C08G 18/61; C08G 18/79; C09D 5/00

(52) U.S. Cl. CPC C09D 175/04; C08G 18/0857; C08G 18/10; C08G 18/246; C08G 18/61; C08G 18/792; C09D 5/00

(57) ABSTRACT

A durable solid and liquid repellant material is provided having an elastomeric matrix with a plurality of lubricating domains distributed therein formed by a partial crosslinking reaction between an elastomeric precursor having a first reactive functional group and a polyol having a second reactive functional group. The polyol has a limited solubility circle. The first reactive functional group is selected from the group consisting of: alkene, amine, carboxylic acid, hydroxyl, isocyanate, and combinations thereof and the second reactive group is selected from the group consisting of: amine, carboxylic acid, hydroxyl group, and combinations thereof. The partially crosslinked elastomeric matrix has a crosslink density of greater than or equal to about 200 mol/m3 and less than or equal to about 2,000 mol/m3. Methods for forming the durable solid and liquid repellant material are also provided.

### CROSS-REFERENCE TO RELATED APPLICATIONS

This application claims the benefit of U.S. Provisional Application No. 63/309,309, filed on Feb. 11, 2022. The disclosure of the above application is incorporated herein by reference in its entirety.

### GOVERNMENT SUPPORT

This invention was made with government support under HR0011833705-00 awarded by the U.S. Department of Defense, Defense Advanced Research Projects Agency. The government has certain rights in the invention.

### FIELD

The present disclosure relates to durable solid and liquid repellant material having a partially crosslinked elastomeric matrix with domains formed from polyol precursors and methods for making the same.

### BACKGROUND

This section provides background information related to the present disclosure which is not necessarily prior art.

Surfaces exposed to real-world conditions are often immersed in complex environments, and face both liquids and solids as potential foulants. Thus, surfaces that are resistant to both liquid and solid fouling are needed for many industrial and biomedical applications. However, surfaces that repel both liquids and solids are rare, yet needed for a variety of applications, including non-stick coatings, controlling protein and cell adhesion on surfaces, engineering surfaces with enhanced resistance to organic solvents, reduction of biofouling, development of finger-print resistant surfaces for flat panel displays, cell-phones, sunglasses/safety glasses, oil pipelines, anti-biofouling surfaces in the maritime industry, limiting condensate liquid or frost formation on heat exchangers, solar panels, biomedical implants, by way of non-limiting example. It is extremely challenging to prevent these fouling processes, because they simultaneously involve multiple phases of foulants and fouling length-scales.

Many existing anti-fouling surface coatings suffer from either poor mechanical durability or limited repellency towards solid foulants (e.g., marine biofouling). Over the past three decades, numerous liquid-repellent surfaces (e.g., superhydrophobic surfaces and superoleophobic surfaces) have been developed by using micro/nanoscale surface textures and low surface energy chemicals. These liquid-repellent surfaces can retain an air layer and form a liquid-solid-air composite interface, which can minimize the contact area between liquid and solid. However, these surfaces intrinsically cannot repel solid foulants or multiphase foulant mixtures because the air layer on which they rely for liquid repellency can be easily replaced by different solid foulants. This removal of the air layer leads to a sharp increase in the adhesion between the foulants and the surface as the underlying surface textures are filled with the solid foulants. In addition, these surfaces based on the careful design of surface micro/nano structures can be easily damaged by mechanical abrasion or scratching.

A few examples of surfaces that can repel a broad range of solid and liquid foulants have been developed recently. These surfaces are designed to form a molecularly smooth surface through liquid lubricants or liquid-like polymer brushes, which replaces the solid-foulant interface to a liquid-foulant interface. In this way, the high mobility of the surface minimizes the adhesion of both liquid and solid foulants. These surface coatings are generally susceptible to mechanical damage/poor mechanical durability and lose their repellent properties when exposed to mild to severe abrasion. For example, slippery liquid-infused surfaces (SLIPS) can be rendered dysfunctional by shear flow or mechanical abrasion. The poor mechanical durability of such surfaces can be attributed to the highly deformable nature of the liquid lubricant or the softness of intermediate chemical layer. Therefore, this durability issue prevents them from being widely implemented in industrial and biomedical settings.
Various approaches have been explored to address this problem, including regeneration of the lubricant/structure, formation of composite materials, or self-healing through thermal stimulation. However, these methods have all been tailored to specific materials/structures and have resulted in only mild durability improvements. Therefore, a general design principle to fabricate mechanically-robust liquid-and-solid repellent surfaces is a challenge to overcome, in order to implement self-cleaning surfaces in harsh working environments. Thus, it would be desirable to develop robust, mechanically durable coatings that exhibit both liquid-and-solid repellency.

### SUMMARY

This section provides a general summary of the disclosure, and is not a comprehensive disclosure of its full scope or all of its features.

In certain aspects, the present disclosure relates to a durable solid and liquid repellant material comprising an elastomeric matrix having a plurality of lubricating domains distributed therein formed by a partial crosslinking reaction between an elastomeric precursor having a first reactive functional group and a polyol. The polyol has a second reactive functional group, a dispersion (δD) solubility parameter of less than or equal to about 22 MPa^{1/2}, and a polar (δP) solubility parameter of less than or equal to about 20 MPa^{1/2}. The first reactive functional group is selected from the group consisting of: alkene, amine, carboxylic acid, hydroxyl, isocyanate, and combinations thereof. The second reactive group is selected from the group consisting of: amine, carboxylic acid, hydroxyl group, and combinations thereof. The elastomeric matrix has a crosslink density of greater than or equal to about 10 mol/m³ and less than or equal to about 2,000 mol/m³.

In one aspect, the elastomeric matrix has an elastic modulus (E) of less than or equal to about 1 GPa and a hardness of greater than or equal to about 30 Shore A hardness.

In one aspect, the hardness is greater than or equal to about 30 Shore A hardness to less than or equal to about 100 Shore A hardness.

In one aspect, the polyol is a compound that comprises at least two hydroxyl groups.

In one aspect, the elastomeric matrix comprises a polyurethane and the first reactive group comprises an isocyanate.

In one further aspect, the elastomeric precursor comprises three isocyanate functional groups.

In one further aspect, the elastomeric precursor comprises a triisocyanate aromatic polyurethane.

In one aspect, a weight ratio of the polyol to the elastomeric precursor is greater than or equal to about 0.5.

In one aspect, a weight ratio of the polyol to the elastomeric precursor is greater than or equal to about 0.75.

In one aspect, the durable solid and liquid repellant material further comprises a free polyol distributed therein.

In one aspect, the durable solid and liquid repellant material has an abrasion resistance parameter (K_{AR}) of greater than 1,000.

In one aspect, the durable solid and liquid repellant material has a transmissivity to wavelengths in the visible range of greater than or equal to about 90%.

In one aspect, the elastomeric precursor forms a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, and combinations thereof. The polyol is selected from the group consisting of: polyphenols, amino acids, hydroxyl- or amino-terminated polydimethylsiloxane, hydroxyl- or amino-terminated per-fluorinated polydimethylsiloxane, natural oils, and combinations thereof.

In one aspect, the elastomer precursor forms a polyurethane and the polyol comprises a hydroxyl-terminated polydimethylsiloxane diol.

In one aspect, the polyol has a molecular weight of greater than or equal to about 100 Da to less than or equal to about 10,000 Da.

In one aspect, after at least 500 abrasion cycles, the durable solid and liquid repellant material has a contact angle hysteresis of less than or equal to about 15° for water and for a predetermined oil.

In certain other aspects, the present disclosure relates to a durable solid and liquid repellant material comprising an elastomeric matrix having a plurality of lubricating domains distributed therein formed by a partial crosslinking reaction between an elastomeric precursor having a first reactive functional group and a polyol. The elastomeric precursor forms a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, and combinations thereof. The polyol is selected from the group consisting of: polyphenols, amino acids, hydroxyl- or amino-terminated polydimethylsiloxane, hydroxyl- or amino-terminated per-fluorinated polydimethylsiloxane, natural oils, and combinations thereof. The elastomeric matrix has a crosslink density of greater than or equal to about 10 mol/m³ and less than or equal to about 2,000 mol/m³, an elastic modulus (E) of less than or equal to about 1 GPa, and a hardness of greater than or equal to 30 Shore A hardness.

In one aspect, the polyol is selected from the group consisting of: catechin, hesperetin, cyanidin, quercetin, caffeic acid, catechol, gallic acid, tannic acid, epigallocatechin, epicatechin gallate, and epigallocatechin gallate, phenylalanine, valine, threonine, tryptophane, isoleucine, methionine, histidine, arginine, leucine, and lysine, hydroxyl- or amino-terminated polydimethylsiloxane, hydroxyl- or amino-terminated per-fluorinated polydimethylsiloxane coconut oil, essential oils, castor oil, sunflower seed oil, jojoba oil, grapeseed oil, and combinations thereof.

In one aspect, the polyol has a molecular weight of greater than or equal to about 100 Da to less than or equal to about 10,000 Da.

In one aspect, the polyol is a compound that comprises at least two hydroxyl groups.

In one aspect, the elastomeric matrix comprises a polyurethane and the first reactive group comprises an isocyanate.

In one further aspect, the elastomeric precursor comprises three isocyanate functional groups.

In one further aspect, the elastomeric precursor comprises a triisocyanate aromatic polyurethane.

In one aspect, a weight ratio of the polyol to the elastomeric precursor is greater than or equal to about 0.5.

In one aspect, a weight ratio of the polyol to the elastomeric precursor is greater than or equal to about 0.75.

In one aspect, the durable solid and liquid repellant material further comprises a free polyol distributed therein.

In one aspect, the durable solid and liquid repellant material has an abrasion resistance parameter (K_{AR}) of greater than 1,000.

In one aspect, the durable solid and liquid repellant material has a transmissivity to wavelengths in the visible range of greater than or equal to about 90%.

In one aspect, the elastomer precursor forms a polyurethane and the polyol comprises a hydroxyl-terminated polydimethylsiloxane diol.

In one aspect, after at least 500 abrasion cycles, the durable solid and liquid repellant material has a contact angle hysteresis of less than or equal to about 15° for water and for a predetermined oil.

In certain further aspects, the present disclosure relates to a durable solid and liquid repellant material comprising an elastomeric urethane-based polymeric matrix having a plurality of lubricating domains distributed therein formed from a partial cross-linking reaction between an elastomeric urethane-based precursor having an isocyanate functional group and a polyol having a second reactive functional group selected from the group consisting of: amine, carboxylic acid, hydroxyl group, and combinations thereof. The polyol is selected from the group consisting of: catechin, hesperetin, cyanidin, quercetin, caffeic acid, catechol, gallic acid, tannic acid, epigallocatechin, epicatechin gallate, and epigallocatechin gallate, phenylalanine, valine, threonine, tryptophane, isoleucine, methionine, histidine, arginine, leucine, and lysine, hydroxyl- or amino-terminated polydimethylsiloxane, hydroxyl- or amino-terminated per-fluorinated polydimethylsiloxane coconut oil, essential oils, castor oil, sunflower seed oil, jojoba oil, grapeseed oil, and combinations thereof. The elastomeric urethane-based polymeric matrix has a crosslink density of greater than or equal to about 10 mol/m³ and less than or equal to about 2,000 mol/m³, an elastic modulus (E) of less than or equal to about 1 GPa, and a hardness of greater than or equal to 30 Shore A hardness.

In one aspect, the polyol is a compound that comprises at least two hydroxyl groups.

In one further aspect, the elastomeric urethane-based precursor comprises three isocyanate functional groups.

In one further aspect, the elastomeric urethane-based precursor comprises a triisocyanate aromatic polyurethane.

In one aspect, a weight ratio of the polyol to the elastomeric urethane-based precursor is greater than or equal to about 0.5.

In one aspect, a weight ratio of the polyol to the elastomeric urethane-based precursor is greater than or equal to about 0.75.

In one aspect, the durable solid and liquid repellant material further comprises a free polyol distributed therein.

In one aspect, the durable solid and liquid repellant material has an abrasion resistance parameter (K_{AR}) of greater than 1,000.

In one aspect, the durable solid and liquid repellant material has a transmissivity to wavelengths in the visible range of greater than or equal to about 90%.

In one aspect, the polyol comprises a hydroxyl-terminated polydimethylsiloxane diol.

In one aspect, the polyol has a molecular weight of greater than or equal to about 100 Da to less than or equal to about 10,000 Da.

In one aspect, after at least 500 abrasion cycles, the durable solid and liquid repellant material has a contact angle hysteresis of less than or equal to about 15° for water and for a predetermined oil.

In certain aspects, the present disclosure still further relates to a method of making a durable solid and liquid repellant material. The method may comprise mixing (i) an elastomeric precursor having a first reactive functional group selected from the group consisting of: alkene, amine, carboxylic acid, hydroxyl, isocyanate, and combinations thereof, (ii) a polyol having a second reactive functional group selected from the group consisting of: amine, carboxylic acid, hydroxyl group, and combinations thereof, a dispersion (δD) solubility parameter of less than or equal to about 22 MPa^{1/2}, and a polar (δP) solubility parameter of less than or equal to about 20 MPa^{1/2}, and (iii) a catalyst to form an admixture. The method further comprises heating the admixture and applying the admixture to a surface of a substrate comprising reactive groups capable of reacting with the first reactive functional group. The method further includes curing the admixture to promote a partial crosslinking reaction between the first reactive functional group and the second reactive functional group to form an elastomeric matrix disposed over the substrate, the elastomeric matrix having a plurality of lubricating domains distributed therein and a crosslink density of greater than or equal to about 10 mol/m³ and less than or equal to about 2,000 mol/m³. The method also comprises annealing the elastomeric matrix to form the durable solid and liquid repellant material.

In one aspect, the mixing further comprises first mixing the (i) elastomeric precursor and (ii) polyol in a solvent for greater than or equal to about 15 minutes, followed by adding the (iii) catalyst in solvent and mixing the admixture for at least 5 minutes, followed by sonication of the admixture.

In one aspect, the heating is conducted for at least 90 minutes at greater than or equal to about 90° C.

In one aspect, the substrate comprises glass and the reactive groups on the surface of the substrate comprise amine (—NH₂) functional groups and the method further comprises prior to the mixing, exposing the surface to oxygen plasma for forming surface hydroxides, reacting the surface with bis(3-trimethoxysilylpropyl) amine to form the amine reactive groups.

In one aspect, the curing is conducted in a vacuum oven in an environment substantially free of water.

In one aspect, the curing is conducted at greater than or equal to about 20° C. to less than or equal to about 70° C. for greater than or equal to about 4 hours to less than or equal to about 48 hours.

In one aspect, the elastomeric matrix has an elastic modulus (E) of less than or equal to about 1 GPa and a hardness of greater than or equal to 30 Shore A hardness.

In one aspect, the polyol is a compound that comprises at least two hydroxyl groups.

In one aspect, the elastomeric matrix comprises a polyurethane and the first reactive group comprises an isocyanate.

In one aspect, the elastomeric precursor comprises three isocyanate functional groups.

In one aspect, the elastomeric precursor comprises a triisocyanate aromatic polyurethane.

In one aspect, a weight ratio of the polyol to the elastomeric precursor is greater than or equal to about 0.5.

In one aspect, a weight ratio of the polyol to the elastomeric precursor is greater than or equal to about 0.75.

In one aspect, only a portion of the polyol reacts with the elastomeric precursor, so that a portion of unreacted polyol is distributed within the elastomeric matrix as a free polyol.

In one aspect, the durable solid and liquid repellant material has an abrasion resistance parameter (K_{AR}) of greater than 1,000.

The In one aspect, the durable solid and liquid repellant material has a transmissivity of greater than or equal to about 90% to wavelengths in the visible range.

In one aspect, the elastomeric precursor forms a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, and combinations thereof and the polyol is selected from the group consisting of: polyphenols, amino acids, hydroxyl- or amino-terminated polydimethylsiloxane, hydroxyl- or amino-terminated per-fluorinated polydimethylsiloxane, natural oils, and combinations thereof.

In one aspect, the elastomer precursor forms a polyurethane and the polyol comprises a hydroxyl-terminated polydimethylsiloxane diol.

In one aspect, the polyol has a molecular weight of greater than or equal to about 100 Da to less than or equal to about 10,000 Da.

In one aspect, after at least 500 abrasion cycles, the durable solid and liquid repellant material has a contact angle hysteresis of less than or equal to about 15° for water and for a predetermined oil.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1E. FIG. 1A shows a reactive oil infusion process for fabricating an omniphobic polyurethane (omni-PU) surface in accordance with certain aspects of the present disclosure. FIG. 1B shows a schematic illustrating the chemical structures of the precursors, including a polyol (polydimethyl siloxane (PDMS) diol) and elastomer precursor (aromatic isocyanate). FIG. 1C shows the reactive oil infusion process to form an omni-PU polymeric layer that is applied to a functionalized surface of a substrate. FIG. 1D shows an optical image demonstrating the liquid repellency of the omni-PU coating. FIG. 1E shows an omniphobic lubricant coating layer on a substrate having partial crosslinking between the elastomer precursor and polyol prepared in accordance with certain aspects of the present disclosure.

FIGS. 2A-2B show liquid repellency of an omni-PU material coating with precursors including a polyol (polydimethyl siloxane (PDMS) diol) and elastomer precursor (aromatic isocyanate) prepared in accordance with certain aspects of the present disclosure. More specifically, in FIG. 2A, contact angle and contact angle hysteresis measurements on the omni-PU with different PDMS diol oil precursor contents are shown. The testing liquid was DI water at 5 μL. FIG. 2B shows contact angle and contact angle hysteresis measurement on the omni-PU with different testing liquids of 5 μL. The error bar was obtained from at least 5 independent measurements.

FIGS. 3A-3B show the optical transparency characterization on an omni-PU material coating formed with precursors including a polyol (polydimethyl siloxane (PDMS) diol) and elastomer precursor (aromatic isocyanate) prepared in accordance with certain aspects of the present disclosure. FIG. 3A shows a transmittance measurement on thick (approximately 300 μm) and thin (approximately 30 μm) omni-PU on glass and the control surface (glass). FIG. 3B shows a transmittance measurement on the fluorinated omni-PU on glass and a control surface (glass).

FIGS. 4A-4B show mechanical durability characterization on omni-PU and the state-of-the-art control. FIG. 4A shows contact angle change for a water droplet (5 μL) on omni-PU prepared in accordance with certain aspects of the present disclosure and control surfaces, including polyurethane, perfluorinated silanized silicon, and the slippery omni-phobic covalently attached liquid (SOCAL) coating over the Taber abrasion test. FIG. 4B shows advancing contact angle, static contact angle, and receding contact angle measurement of water and hexadecane (5 μL) on omni-PU prepared in accordance with certain aspects of the present disclosure over Taber abrasion test. The Taber abrasion used 800-gram weight with CS-10 under 60 cycles/min linear motion. The error bar was obtained from at least 5 independent measurements.

FIGS. 5A-5B show marine algae fouling testing on omni-PU. FIG. 5A shows algae coverage area fraction on omni-PU and other control surfaces (polyurethane (PU), polydimethylsiloxane (PDMS, SYLGARD™ 184), and glass) for 60 days. FIG. 5B shows optical microscopy images comparing omni-PU and other controls after 25 days of algal fouling. The error bar was obtained from at least 3 independent measurements.

FIGS. 6A-6C show factors related to designing of omniphobic polyurethane (omni-PU) coatings. In FIG. 6A, liquid repellency design by Hansen solubility parameters is shown. The circles are the Hansen solubility circles for corresponding polyols. In FIG. 6B, a schematic illustrating the chemical reaction of the polyol and the tri-isocyanate to form an omniphobic polyurethane durable solid and liquid repellant material prepared in accordance with certain aspects of the present disclosure is shown. In FIG. 6C, a Hansen solubility circle of ethylene glycol based on a group of probing liquids is shown as a control for comparison.

FIGS. 7A-7C. Fabrication and liquid repellency of omni-PU. FIG. 7A shows an optical photograph showing omni-PU in accordance with certain aspects of the present disclosure and its liquid repellency to KRYTOX™ 103, hexadecane, ethylene glycol, and water. FIG. 7B shows contact angle and contact angle hysteresis measurements on omni-PU with varying PDMS diol oil content. The testing liquid is deionized (DI) water with 5 microliters (μL). FIG. 7C shows contact angle and contact angle hysteresis measurements on the omni-PU with different testing liquids of 5 μL. The error bars were obtained from at least 5 independent measurements.

FIGS. 8A-8E show mechanical durability characterizations of omni-PU prepared in accordance with certain aspects of the present disclosure and conventional repellant material controls. FIG. 8A shows a schematic of the Taber abrasion test, and a scanning electron microscope (SEM) image showing the topography of the CS-10 abrader. FIG. 8B shows surface roughness measurements of omni-PU and PDMS after 1,000 cycles of mechanical abrasion. Errors were obtained from the at least 3 independent measurements. FIG. 8C shows a change in contact angle hysteresis for water droplets (5 μL) on omni-PU with polyol-to-isocyanate ratio of 1:1 and the control surfaces over the Taber abrasion test. FIG. 8D shows advancing contact angle, static contact angle, and receding contact angle measurements with water and hexadecane (5 μL) on omni-PU throughout the Taber abrasion test. FIG. 8E shows the value of |cos θ/cos θ_{Y}−1| versus number of abrasion cycles for the omni-PU and various control surfaces. The error bars were obtained from at least 5 independent measurements.

FIGS. 9A-9D. Solid fouling tests on omni-PU prepared in accordance with certain aspects of the present disclosure and various control surfaces. FIG. 9A shows bacteria (E. coli) adhesion on the omni-PU and PU surfaces. The inset fluorescent images compare the attached bacterial cells on the surfaces. FIG. 9B show algae coverage area fraction on omni-PU and other control surfaces with and without abrasion (PU, iPU, PDMS, and glass) for 30 days. Optical microscopy images compare the omni-PU and control surfaces after 15 days of algal fouling. FIG. 9C show ice adhesion strength on various surfaces before and after durability testing (cyclic icing/deicing and mechanical abrasion). FIG. 9D show summary chart illustrating the repellency of omni-PU to solid foulants with a wide range of modulus and length scales. The inset images from left to right are the microscopic fluorescent image of E. coli, the microscopic image of Ulva fasciata cells containing spores, the SEM image of a diatom, and the optical image of ice block pushed by a force gauge probe. The error bar was obtained from at least 3 independent measurements.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Unless otherwise indicated, percentages and ratios are by mass/weight.

The disclosures and relevant content of all references cited or discussed in this disclosure are incorporated by reference herein, unless otherwise indicated.

Example embodiments will now be described more fully with reference to the accompanying drawings.

In various aspects, the present disclosure provides solid-and-liquid repellent elastomeric coatings that incorporate partially crosslinked lubricating chains within a durable polymer matrix. As used herein, the polymeric matrix need not have any reinforcing phase. In various aspects, the coating is applied to a substrate, which can form a surface exhibiting solid and liquid repellant or omniphobic properties. By “omniphobic” as used herein, it is meant that a surface of a substrate or a material exhibits both hydrophobic and oleophobic properties towards liquids, including with respect to water or other polar liquids (e.g., alcohols, dimethyl formamide and the like), as well as to oils and solids. While traditionally, the term omniphobic refers only to the ability to repel water and oil, in accordance with various aspects of the present disclosure, the term omniphobic means the surface is not only repellant with respect to liquids, but is repellant to solids, as well.

Surfaces that display a contact angle of greater than or equal to about 90° with water or other polar liquids (e.g., alcohols, dimethyl formamide and the like) are considered to be “hydrophobic.” Superhydrophobic surfaces are those that display a contact angle of greater than or equal to about 150° along with low contact angle hysteresis (difference between the advancing θ_{adv} and the receding contact angle θ_{rec}) with water or other preselected polar liquids. In certain variations, a “superhydrophobic” surface has a contact angle of greater than or equal to about 150° with water or another polar liquid having a high surface tension.

Surfaces that display a contact angle of greater than or equal to about 90° with a preselected oil are considered to be “oleophobic.” A “preselected oil” is intended to include any oil or combinations of oils of interest. As discussed herein, in certain non-limiting variations, an exemplary preselected oil used to demonstrate oleophobicity/oleophilicity is rapeseed oil (RSO). Superoleophobic surfaces are those that display a contact angle of greater than or equal to about 150° along with low contact angle hysteresis with preselected low surface tension liquids, such as a representative oil (for example, rapeseed oil (RSO)).

Generally, the omniphobic surfaces prepared in accordance with certain aspects of the present disclosure can repel liquids with a wide range of surface tensions, for example, ranging from greater than or equal to about 10 mN/m to less than or equal to about 72 mN/m. Further, the omniphobic surfaces exhibit solid repellency. For example, the durable solid and liquid repellant material defines an exposed surface that reduces adhesion of solid foulants by greater than or equal to 30% after 30 days as compared to an exposed surface of a comparative polymeric material (for example, the same type of elastomeric material as the inventive coating material, but lacking the crosslinked lubricating domains described further below). For example, solid repellency of the coatings prepared in accordance with the present disclosure may reduce adhesion of a solid foulant on the surface by greater than or equal to about 30%, optionally greater than or equal to about 50%, and in certain aspects, optionally greater than or equal to about 70% as compared to the comparative polymeric material, for a period of time, for example, 30 days.

In certain aspects, the present disclosure contemplates a durable solid and liquid repellant material comprising an elastomeric layer having a plurality of lubricating domains distributed therein. The elastomeric material having a plurality of lubricating domains is formed by a crosslinking reaction between an elastomeric precursor having a first reactive functional group and a polyol having a second reactive functional group and a narrow solubility circle, as will be defined further below. In certain aspects, the crosslinking reaction is only a partial crosslinking reaction, so that a portion of the available functional groups on the elastomeric precursor are reacted with functional groups on the polyol, while a portion of the elastomeric precursor functional groups remain unreacted. In certain variations, greater than or equal to about 20% of the functional groups react, optionally greater than or equal to about 50% of the functional groups react. In certain aspects, the durable solid and liquid repellant material further comprises a free polyol distributed therein, for example, unreacted polyol remains in the material. In certain aspects, the partial crosslinking may be expressed by a crosslink density in the material.

By way of example, in accordance with certain variations of the present teachings, the durable solid and liquid repellant material comprises a crosslinked elastomeric polymer with lubricating domains defined by the polyols having a relatively low crosslink density reflecting the partial crosslinking. In certain aspects, for example where a hydroxyl terminated polydimethylsiloxane is used as a polyol reacted to form a polyurethane crosslinked elastomeric matrix, the material may have a crosslink density of greater than or equal to about 10 mol/m³ to less than or equal to about 2,000 mol/m³, optionally greater than or equal to about 25 mol/m³ to less than or equal to about 2,000 mol/m³, optionally greater than or equal to about 50 mol/m³ to less than or equal to about 2,000 mol/m³, optionally greater than or equal to about 100 mol/m³ to less than or equal to about 2,000 mol/m³, and in certain aspects, optionally greater than or equal to about 200 mol/m³ to less than or equal to about 2,000 mol/m³. However, it should be noted that crosslink density may vary depending on the specific polymer and lubricating domain systems used. In certain variations, the elastomeric material may have a crosslink density that is greater than or equal to about 250 mol/m³ to less than or equal to about 1,900 mol/m³, optionally greater than or equal to about 500 mol/m³ to less than or equal to about 1,750 mol/m³, and optionally greater than or equal to about 750 mol/m³ to less than or equal to about 1,500 mol/m³.

In certain aspects, an article may be formed from or include a structural surface layer of the durable solid and liquid repellant material. In other aspects, the solid and liquid repellant materials of the present disclosure may be in the form of a coating on an article, which may be applied to a variety of different surfaces or substrates. The coating materials of the present disclosure are generally compatible with a wide range of substrate materials. Therefore, in certain exemplary embodiments, the substrate may be porous or non-porous and may formed of plastic or polymeric materials, metallic materials, inorganic materials, organic materials (such as materials derived from plants or animals), and combinations thereof. In certain aspects, the substrate is constructed from one or more materials selected from the group consisting of metal, such as sheet metal, cast metal, forged metal, and the like, composite materials comprising resin and reinforcing materials, plastic or polymeric materials, screens, mesh, paper, fibrous materials and cloth, foam, equivalents, and combinations thereof. The substrate may also comprise a plurality of three-dimensional structures, such as pillars, nubs, posts, ribs, and the like.

In certain aspects, a cross linker may be included in the durable solid and liquid repellant material. Such a crosslinker may be an amine-based silane with an NH₂-group, which exhibits strong adhesion to certain polymers (e.g., omniphobic polyurethane (“omni-PU”) coatings), such as bis(3-trimethoxysilylpropyl) amine. Surface hydroxyl groups can also be used to adhere the durable solid and liquid repellant material coating to the substrate. For example, the substrate may be treated with an oxygen plasma treatment to form hydroxyl groups on the surface thereof.

In certain variations, where the durable solid and liquid repellant materials of the present disclosure are in the form of a polymeric or elastomeric coating on a surface or substrate, the coating may have a thickness of greater than or equal to about 0.5 micrometers (μm), optionally greater than or equal to about 1 μm, optionally greater than or equal to about 5 μm, optionally greater than or equal to about 10 μm, optionally greater than or equal to about 25 μm, optionally greater than or equal to about 50 μm, optionally greater than or equal to about 75 μm, optionally greater than or equal to about 100 μm, optionally greater than or equal to about 200 μm, optionally greater than or equal to about 300 μm, optionally greater than or equal to about 400 μm, optionally greater than or equal to about 500 μm, optionally greater than or equal to about 600 μm, optionally greater than or equal to about 700 μm, optionally greater than or equal to about 800 μm, optionally greater than or equal to about 900 μm, optionally greater than or equal to about 1,000 μm (1 mm), optionally greater than or equal to about 2,000 μm (2 mm), optionally greater than or equal to about 3,000 μm (3 mm), optionally greater than or equal to about 4,000 μm (4 mm), and in certain variations, optionally greater than or equal to about 5,000 μm (5 mm). In certain aspects, the durable solid and liquid repellant coating materials of the present disclosure may optionally have a thickness ranging from greater than or equal to about 1 μm to less than or equal to about 5 mm. In certain other variations, the durable solid and liquid repellant coating materials of the present disclosure may optionally have a thickness ranging from greater than or equal to about 100 μm to less than or equal to about 1,000 μm.

As will be described further herein, an elastomer, also referred to herein interchangeably as a rubber, forms the polymeric matrix and in certain variations, an elastomeric precursor that forms an elastomeric matrix exhibits elastomeric properties. Young's modulus is a ratio of stress (σ) to strain (ε) when deformation is in the elastic region and stress and strain are proportional, and is often referred to as elastic modulus (E). In certain aspects, the elastomer formed has an elastic modulus of less than or equal to about 1 GPa, for example, less than or equal to about 500 MPa, optionally less than or equal to about 200 MPa, optionally less than or equal to about 100 MPa, optionally less than or equal to about 50 MPa, optionally less than or equal to about 20 MPa, optionally less than or equal to about 10 MPa, and in certain aspects, optionally less than or equal to about 5 MPa. The elastomeric material may have a hardness of greater than or equal to about 30 Shore A hardness. In certain variations, the elastomeric material may have an elastic modulus (E) of greater than or equal to about 1 MPa to less than or equal to about 1 GPa and a hardness of greater than or equal to about 30 Shore A to less than or equal to about 100 Shore A hardness. In certain variations, an elastomeric precursor may be a monomer, oligomer, or polymer that has one or more functional or reactive groups available for crosslinking or other reaction. By way of example, one polyol precursor may be a polydimethylsiloxane (PDMS) diol that is an oligomer and may have a molecular weight of greater than or equal to about 100 Da to less than or equal to about 10,000 Da (10 kDa).

In certain variations, an elastomeric precursor that forms the elastomeric matrix has a first reactive functional group capable of reacting with a polyol having a second reactive functional group, as will be described further below. The first reactive functional group may be selected from the group consisting of: alkene (—C═C), amine (—NH₂), carboxylic acid (—C═O(OH)), hydroxyl (—OH), isocyanate (—N═C═O), and combinations thereof. In certain aspects, the elastomeric precursor may form a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, copolymers and combinations thereof. In one particular variation, the elastomeric precursor is a polyurethane with isocyanate reactive groups, for example, it may be a triisocyanate polyurethane precursor having three isocyanate reactive groups. In certain variations, the elastomeric precursor may be an aromatic polyurethane with isocyanate groups, such as a triisocyanate aromatic polyurethane monomer.

The elastomeric matrix further includes a plurality of lubricating domains anchored to and distributed therein. In certain variations, the plurality of lubricating domains may be distributed evenly or homogeneously throughout the elastomeric matrix. The plurality of lubricating domains may be attached via a crosslinking reaction (e.g., covalently bonded) to the elastomeric matrix. The plurality of lubricating domains may be formed by polyols that have at least one functional group capable of reacting with functional/reactive groups on the elastomer in the matrix. In certain variations, the functional or reactive group of the polyol is selected from the group consisting of: amine (—NH₂), carboxylic acid (—C═O(OH)), hydroxyl group (—OH), and combinations thereof. In certain variations, each polyol has at least two reactive groups. For example, a polyol has at least two hydroxyl groups and thus is a diol or may have more than two hydroxyl groups (e.g., triol, tetraol, pentaol). As will be described further herein, in certain variations, a precursor forms the polymeric matrix formed by a partial crosslinking reaction between an elastomeric precursor having a first reactive functional group discussed above and a polyol having the second reactive functional group and a narrow solubility circle. In certain variations, greater than or equal to about 20% of the functional groups react, optionally greater than or equal to about 50% of the functional groups react. For example, greater than or equal to about 20% to less than or equal to about 75% of the functional groups react, optionally greater than or equal to about 50% to less than or equal to about 65% of the functional groups react.

A narrow solubility circle means that the polyols are only soluble in select liquids, rather than having a large solubility circle where the polyol is soluble in high polar and low polar, and sometimes even nonpolar liquids. The solubility circle may be expressed as a Hansen solubility parameters or a solubility circle considering several of these parameters. The Hansen solubility circles are defined as the minimal circular area that can cover all of the liquids that are soluble in the corresponding polyols. In certain aspects, a suitable polyol may have a dispersion (δD) parameter of less than or equal to about 22 MPa^{1/2}, for example, from greater than 0 to less than or equal to about 22 MPa^{1/2}. The polar (δP) solubility parameter may be less than or equal to about 20 MPa^{1/2}, for example, from greater than 0 to less than or equal to about 20 MPa^{1/2}. In certain aspects, the polyol has both a dispersion (δD) parameter of less than or equal to about 22 MPa^{1/2}, for example, from greater than 0 to less than or equal to about 22 MPa^{1/2} and a polar (δP) solubility parameter of less than or equal to about 20 MPa^{1/2}, for example, from greater than 0 to less than or equal to about 20 MPa^{1/2}.

In certain variations, the polyol is selected from the group consisting of: polyphenols, amino acids, hydroxyl- or amino-terminated polydimethylsiloxane (PDMS), hydroxyl- or amino-terminated per-fluorinated polydimethylsiloxane (PDMS), natural oils, and combinations thereof. In certain variations, the polyol is selected from the group consisting of: catechin, hesperetin, cyanidin, quercetin, caffeic acid, catechol, gallic acid, tannic acid, epigallocatechin, epicatechin gallate, and epigallocatechin gallate, phenylalanine, valine, threonine, tryptophane, isoleucine, methionine, histidine, arginine, leucine, and lysine, hydroxyl- or amino-terminated polydimethylsiloxane, hydroxyl- or amino-terminated per-fluorinated polydimethylsiloxane coconut oil, essential oils (oil products extracted or isolated from natural sources), castor oil, sunflower seed oil, jojoba oil, grapeseed oil, and combinations thereof. However, it should be noted that polyols having a high solubility circle are excluded as being unsuitable polyols in certain variations, which excludes polyols like ethylene glycol, ethanol, methanol, isopropanol, and the like. In certain variations, the polyol that forms the lubricating domains has a molecular weight of greater than or equal to about 100 Da to less than or equal to about 10,000 Da.

In certain aspects, the solid-and-liquid repellent elastomeric materials provided herein exhibit abrasion resistance. Current liquid and/or solid repellent coatings are generally susceptible to mechanical damage, particularly under harsh abrasion conditions. Specifically, in certain variations, solid-and-liquid-repellant/omniphobic materials prepared in accordance with certain aspects of the present disclosure can withstand over ten times greater harsh abrasion cycles than current omniphobic coatings. An abrasion cycle may be mechanical abrasion performed in accordance with ASTM standard D4060, for example, by using a rotary TABER® Abrasion machine with a CS-10 resilient abrader and a total weight of 60 g. The abrader is refaced before each set of abrasion cycles using sand paper (from Taber®). Refacing may be done at 25 cycles/min for 25 cycles. For abrasion, a sample having the omniphobic/solid and liquid repellant surface may be clamped down and abraded for up to 5,000 cycles at 60 cycles/min. After a total number of mechanical abrasion cycles are completed, the sample is assessed for its properties, for example, an apparent advancing dynamic contact angle and roll-off angle for water.

In certain aspects, the durable or robust solid and liquid repellant materials properties, a contact angle (or advancing angle) can have a vary, for example, from greater than or equal to about 40° to about 120°, but the surface can maintain a low contact angle hysteresis after mechanical abrasion, such as after at least about 100 abrasion cycles.

For example, solid repellency of the coatings prepared in accordance with the present disclosure may reduce adhesion of a solid foulant on the surface by greater than or equal to about 30%, optionally greater than or equal to about 50%, and in certain aspects, optionally greater than or equal to about 70% as compared to the comparative polymeric material, for a period of time, for example, 30 days.

In certain variations, the solid and liquid repellant/omniphobic surface exhibits both a contact angle of greater than or equal to about 90°, optionally greater than or equal to about 150°, and a roll-off angle of less than or equal to about 30°, optionally less than or equal to about 15° for water after greater than or equal to about 150 abrasion cycles. In other variations, the solid and liquid repellant/omniphobic surface exhibits both such a contact angle (of greater than or equal to about 90° or optionally greater than or equal to about) 150° and a roll-off angle (of less than or equal to about 30, optionally less than or equal to about) 15° for both water and oil after greater than or equal to about 200 abrasion cycles, optionally after greater than or equal to about 300 abrasion cycles, optionally after greater than or equal to about 400 abrasion cycles, optionally after greater than or equal to about 500 abrasion cycles, optionally after greater than or equal to about 600 abrasion cycles, optionally after greater than or equal to about 700 abrasion cycles, optionally after greater than or equal to about 800 abrasion cycles, optionally after greater than or equal to about 900 abrasion cycles, and in certain aspects, optionally after greater than or equal to about 1,000 abrasion cycles.

In certain variations, the solid and liquid repellant/omniphobic or superomniphobic surface exhibits a contact angle hysteresis of less than or equal to about 15° for water and a preselected oil, optionally less than or equal to about 10° for water and a preselected oil, optionally less than or equal to about 5° for water and a preselected oil, and in certain variations, the contact angle hysteresis may be less than or equal to about 3° for water and a preselected oil.

In other aspects, the solid and liquid repellant/omniphobic or superomniphobic material has a contact angle hysteresis of less than or equal to about 15°, optionally less than or equal to about 10°, optionally less than or equal to about 5°, optionally less than or equal to about 3° for water and a preselected oil after greater than or equal to about 100 abrasion cycles, optionally greater than or equal to about 150 abrasion cycles, optionally after greater than or equal to about 200 abrasion cycles, optionally after greater than or equal to about 300 abrasion cycles, optionally after greater than or equal to about 400 abrasion cycles, optionally after greater than or equal to about 500 abrasion cycles, optionally after greater than or equal to about 600 abrasion cycles, optionally after greater than or equal to about 700 abrasion cycles, optionally after greater than or equal to about 800 abrasion cycles, optionally after greater than or equal to about 900 abrasion cycles, and in certain aspects optionally after greater than or equal to about 1,000 abrasion cycles.

In one variation, after at least 500 abrasion cycles, the durable solid and liquid repellant/omniphobic or superomniphobic material has a contact angle hysteresis of less than or equal to about 15° for water and for a predetermined oil (e.g., rapeseed oil (RSO)). In this manner, a durable lubricated smooth surface is created that can maintain a low contact angle hysteresis after mechanical abrasion for both water and a predetermined oil. In certain aspects, optionally after greater than or equal to about 600 abrasion cycles, optionally after greater than or equal to about 700 abrasion cycles, optionally after greater than or equal to about 800 abrasion cycles, optionally after greater than or equal to about 900 abrasion cycles, and in certain aspects optionally after greater than or equal to about 1,000 abrasion cycles, the contact angle hysteresis is less than or equal to about 15° for water and the predetermined oil.

In certain other variations, the solid and liquid repellant/omniphobic material is wherein the durable solid and liquid repellant material defines a surface exhibiting solid repellency. For example, such solid repellency may be where adhesion of solid foulant on the surface is minimized or reduced by greater than or equal to about 30%, optionally greater than or equal to about 50%, and in certain aspects, optionally greater than or equal to about 70% as compared to the comparative polymeric material, for a period of time, for example, 30 days. The solid foulants may be infectious bacteria, such as E. coli, soft or hard marine foulants (such as cyanobacteria and diatom), and ice, by way of non-limiting example.

In certain variations, the solid and liquid repellant/omniphobic material is transparent to visible light, for example, having wavelengths ranging from about 390 to about 750 nm. By transparent, it is meant that the material is transmissive for a target range of wavelengths of electromagnetic energy, for example, in the visible wavelength ranges. Thus, in certain aspects, a transparent solid and liquid repellant/omniphobic material transmits greater than or equal to about 75% of electromagnetic energy at the predetermined range of wavelengths, optionally greater than or equal to about 80%, optionally greater than or equal to about 85%, optionally greater than or equal to about 90%, and in certain preferred aspects, optionally greater than or equal to about 95% of the electromagnetic energy at the predetermined range of wavelengths (e.g., in the visible range of the spectrum) is transmitted.

The present disclosure thus contemplates the design and fabrication of robust solid and liquid repellant or omniphobic elastomeric coatings using a polyol-reactive infusion method. As noted above, the term omniphobic is used interchangeably herein with solid and liquid repellant in the context of the present disclosure. The ability to concurrently repel liquids and solid foulants for long durations and after experiencing abrasion is particularly advantageous. Specifically, in certain variations, omniphobic polyurethane (“omni-PU”) coatings are prepared through a polyol reactive infusion method to create a partially crosslinked polymer matrix. The reactive oil infusion method provides the ability to use more functional polymers to have the capability to form liquid and solid repellent surfaces, which significantly enables the application of such surfaces in various industrial and medical settings.

Recent studies of using polyurethane as a base polymer matrix have shown high mechanical durability and low adhesion strength towards ice. However, none of these surfaces can repel a wide range of liquids, providing the capability to repel ice as well as other solid foulants. Since polyurethane cannot be swelled by most common alkane oils and silicone oils, the conventional liquid infused method by swelling cannot be applied to form slippery surfaces with polyurethane. Therefore, the present disclosure contemplates new fabrication methods to achieve a mechanically durable and omniphobic polyurethane.

Herein, mechanically durable polymer coatings, which repel a wide range of liquid and solid foulants, may be created. In one variation, silicone-based diols (fluorinated and non-fluorinated hydroxy terminated polydimethylsiloxane (PDMS)) and the durable isocyanate (or polyol and isocyanate) are used as reactants to form the durable slippery omniphobic polyurethane (omni-PU) exhibiting both liquid and solid repellency. To realize improved abrasion resistance, a hard polyurethane (PU) elastomer is selected as the base polymer matrix. The oil (polyol or lubricating regions) reacts with the isocyanate (elastomer) to form the base polymer matrix. Through partial cross-linking of the base polymer with functional polyols, the elastomeric PU coating forms a stable lubrication layer with liquid polyols defining lubricating domains that fully maintain lubrication under abrasion. This not only enhances the mechanical strength of the coating, but also facilitates the repulsion of both liquid and solid foulants. Further, any unreacted free oil can act as the lubrication inside and on top of the polymer.

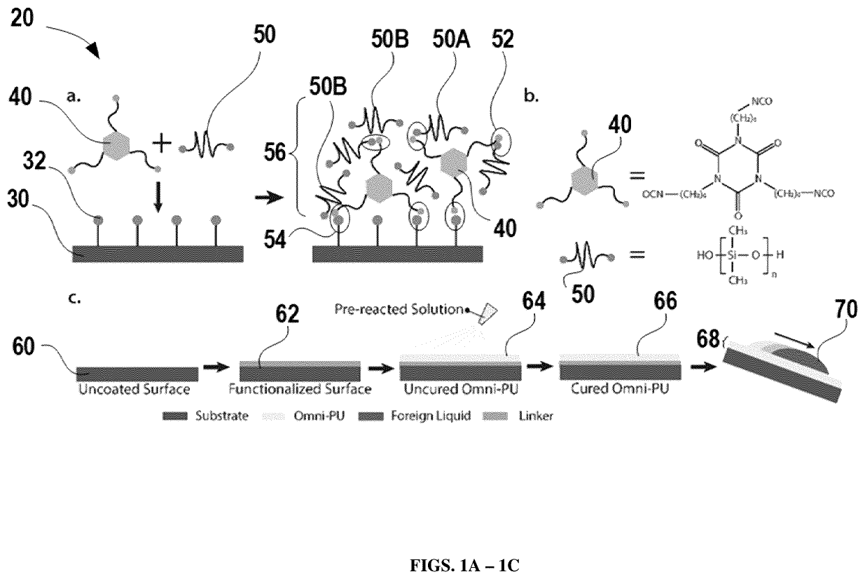

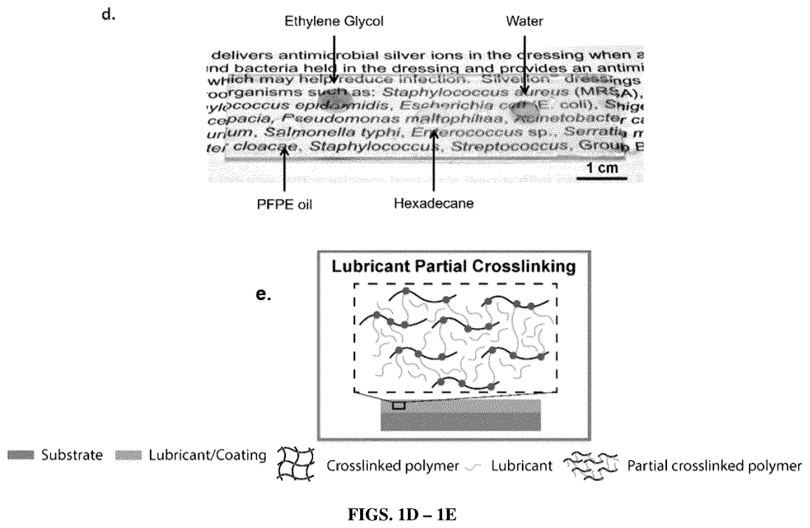

FIGS. 1A-1D demonstrate this principle. In FIG. 1A, an example of a polyol reactive infusion method 20 is shown. A substrate 30 may have reactive groups 32 or may be treated to form a plurality of reactive groups 32, for example, by plasma treatment or treatment with a tie layer or cross linker material. Next, an elastomer monomer 40 having a polyurethane chemical structure is shown in FIG. 1B, which includes a plurality of isocyanate reactive groups, is applied over the substrate 30. The precursor material may also include a polyol 50, here having the hydroxyl terminated siloxane diol structure shown in FIG. 1B. The elastomer monomer 40 and polyol 50 react with one another and the reactive groups 32 on the substrate 30. In this manner, crosslink reactions form connection points 52 between the elastomer monomer 40 and reacted polyol 50A. As will be appreciated, in other variations, less than all of the reactive groups on the elastomer monomer may be reacted with polyol, such as the lubricating layer schematic having a partially crosslinked polymer on the substrate in FIG. 1E. As noted above, in accordance with certain aspects of the present disclosure, only a partial crosslinking reaction occurs, for example, where at least about 20% of the functional groups react, optionally greater than or equal to about 50% of the functional groups react. With renewed reference to FIG. 1A, reactions also occur between the reactive groups 32 and the elastomer monomer 40 to form bonds 54 that anchor a polymeric matrix layer 56 thereto. Notably, a portion of the polyol introduced over the substrate 30 remains as unreacted polyol 50B within the polymer matrix layer 56.

FIG. 1C shows an overview of such a process like in 20. In FIG. 1C, the substrate 60 has an uncoated surface. Then, the surface of the substrate 60 may be functionalized 62, for example, by applying a cross linker composition that reacts with the substrate and provides exposed reactive groups for reaction with the precursors of the polymeric matrix coating. Then, a pre-reacted precursor solution 64 having the elastomer monomer and polyol is applied over the functionalized surface 62. The precursor solution 64 may then be cured for the solidification (e.g., polymerization and/or crosslinking reactions). Finally, after curing, an omni-PU polymeric matrix layer 68 is formed over the substrate 60 that demonstrates liquid repellency (see droplet 70) towards a range of different high surface tension liquids (e.g., water: 72.4 mN/m) and low surface tension liquids (e.g., PFPE oil: 16 mN/m). FIG. 1D shows an optical image demonstrating the liquid repellency of the omni-PU coating over a printed text where ethylene glycol, water, PFPE oil and hexadecane are applied and repelled.

In certain aspects, the present disclosure provides methods of making a durable solid and liquid repellant material. Such a method may comprise mixing (i) an elastomeric precursor having a first reactive functional group selected from the group consisting of: alkene, amine, carboxylic acid, hydroxyl, isocyanate, and combinations thereof, (ii) a polyol having a second reactive functional group selected from the group consisting of: amine, carboxylic acid, hydroxyl group, and combinations thereof, a dispersion (δD) solubility parameter of less than or equal to about 22 MPa^{1/2}, and a polar (δP) solubility parameter of less than or equal to about 20 MPa^{1/2}, and (iii) a catalyst to form an admixture. The mixing may be vortex mixing. The mixing optionally further comprises first mixing the (i) elastomeric precursor and (ii) polyol in a solvent for greater than or equal to about 15 minutes, followed by adding the (iii) catalyst in solvent and mixing the admixture for at least 5 minutes, followed by sonication of the admixture to remove bubbles. In one variation, hydroxy terminated polydimethylsiloxane (PDMS-OH) (Sigma Aldrich) and isocyanate (Covestro, DESMODUR™ N3800) in a methyl isobutyl ketone (MIBK) (Fisher Scientific) solvent are vortex mixed for 15 minutes until the mixture has no bubbles and is optically clear. Then, a catalyst (dibutyltin dilaurate (Fisher Scientific) 0.1 wt. % in MIBK) may be added to the admixture with a weight percentage of 2.67%, followed by 5 minutes of vortex mixing and 10 minutes of sonication to remove bubbles. In certain variations, the mixing pf the admixture may occur for greater than or equal to about 5 minutes to less than or equal to about 20 minutes.

Next, the method may include heating the admixture. In certain variations, the heat may occur at greater than or equal to about 80° C. to less than or equal to about 105° C. for greater than or equal to about 60 minutes to less than or equal to about 120 minutes (2 hours). As will be appreciated by those of skill in the art, the higher the temperature during heating, the shorter the duration of heating. The heating is optionally conducted for at least 90 minutes at greater than or equal to about 90° C.

Then, the admixture may be applied to a surface of a substrate comprising reactive groups capable of reacting with the first reactive functional group. The admixture may be in a liquid or semi-liquid state and thus the applying optionally comprises drop casting or spray coating on the surface of the substrate. The admixture may be dried to remove solvent(s) after it is applied to the substrate.

The admixture may then be cured to promote a partial crosslinking reaction between the first reactive functional group and the second reactive functional group to form an elastomeric matrix disposed over the substrate. By curing, it is meant that there is at least one reaction that may include crosslinking, but may also include polymerization and reaction between functional groups on the surface of the substrate and the elastomeric matrix. The curing process may involve applying heat, actinic radiation (e.g., UV radiation), e-beam radiation, and the like. In certain aspects, the curing may be done in a low pressure or vacuum environment. The elastomeric matrix may have any of the properties described above, including having a plurality of lubricating domains distributed therein and a crosslink density of greater than or equal to about 200 mol/m³ and less than or equal to about 2,000 mol/m³. The curing may be conducted in a vacuum oven. In certain variations, the surrounding environment contains less than or equal to about 10,000 ppm of water (corresponding to about 70% relative humidity at 20° C.), optionally less than or equal to about 7,000 ppm of water (corresponding to about 50% relative humidity at 20° C.), and in certain aspects less than or equal to about 4,000 ppm of water (corresponding to about 30% relative humidity at 20° C.). In certain other variations, the surrounding environment is substantially free of water, meaning for example, less than or equal to about 150 ppm of water (corresponding to less than about 1% relative humidity at 20° C.), optionally less than or equal to about 70 ppm of water (corresponding to about 0.5% relative humidity at 20° C.).

The curing may be conducted at greater than or equal to about 20° C. to less than or equal to about 70° C., optionally greater than or equal to about 40° C. to less than or equal to about 60° C., for greater than or equal to about 4 hours to less than or equal to about 48 hours.

In certain further aspects, the substrate comprises glass (e.g., silicon dioxide, borosilicates, and the like) and the reactive groups on the surface of the substrate comprise amine (—NH₂) functional groups. Prior to the mixing, the surface may be to oxygen plasma for forming surface hydroxides followed by reacting the surface with bis(3-trimethoxysilylpropyl) amine to form the amine reactive groups. For example, surface hydroxylation may be achieved by using an oxygen plasma exposure for 15 minutes with a power of 40 W. In one variation, amine surface functionalization on glass can be performed by the following process: the glass surface is exposed to an oxygen plasma for 15 minutes with a power of 40 W. Then the glass may be placed into a solution of 2 wt. % bis(3-trimethoxysilylpropyl) amine in ethanol (12.5 mL ethanol, 195 μL silane, 0.63 mL of pH=2 acetic acid solution; stirred for 2 h before use) for 20 minutes.

Such methods desirably form a durable solid and liquid repellant material having the properties described above, including abrasion resistance.

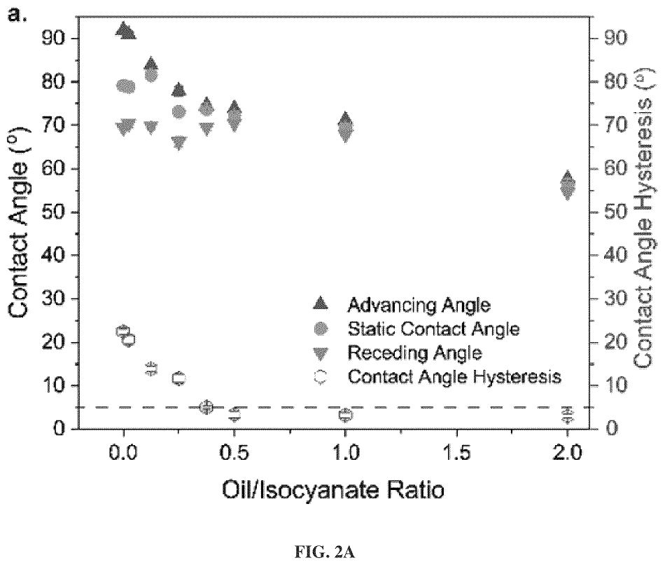

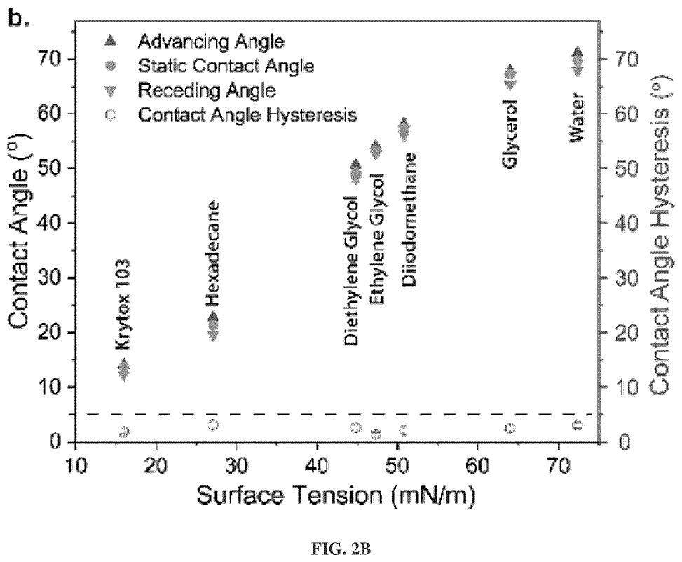

FIGS. 2A and 2B show the effect of premixed oil content percentage on the liquid repellency of the cured omni-PU is shown. Generally, for certain embodiments, an oil to isocyanate ratio is desirably above 0.5 in order to achieve ultra-low contact angle hysteresis to various liquids.

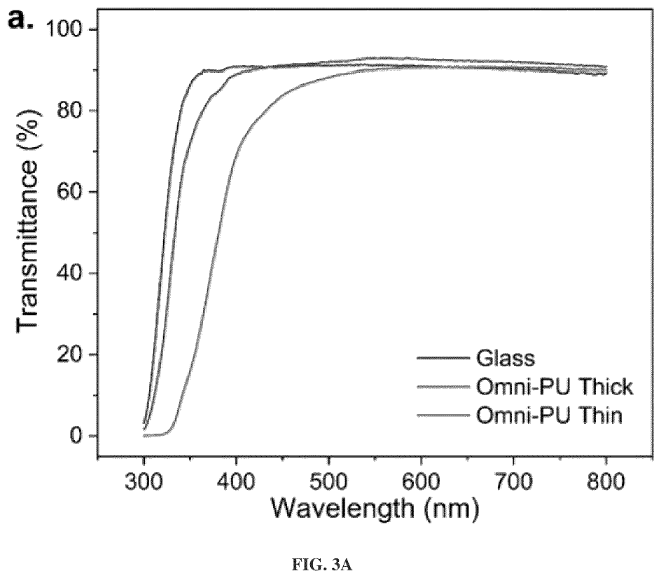

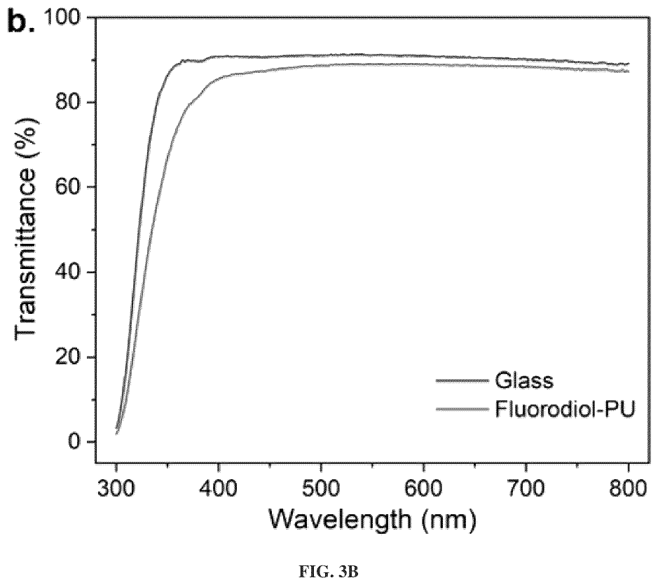

Furthermore, the omni-PU prepared in accordance with certain aspects of the present disclosure is highly transparent and has a comparable transmittance compared to the glass substrates. FIG. 3A shows a transmittance measurement on thick (approximately 300 μm) and thin (approximately 30 μm) omni-PU on glass and the control surface (glass). FIG. 3B shows a transmittance measurement on the fluorinated omni-PU on glass and a control surface (glass).

Omni-PU coatings prepared in accordance with certain aspects of the present disclosure outperformed all state-of-the-art liquid repellent surfaces in the mechanical abrasion tests with an order of magnitude longer durability. In particular, the omni-PU can last after experiencing more than 1,000 cycles of harsh Taber linear abrasion without a significant change in contact angle and contact angle hysteresis to water and hexadecane, while the other surfaces failed within 100 cycles.

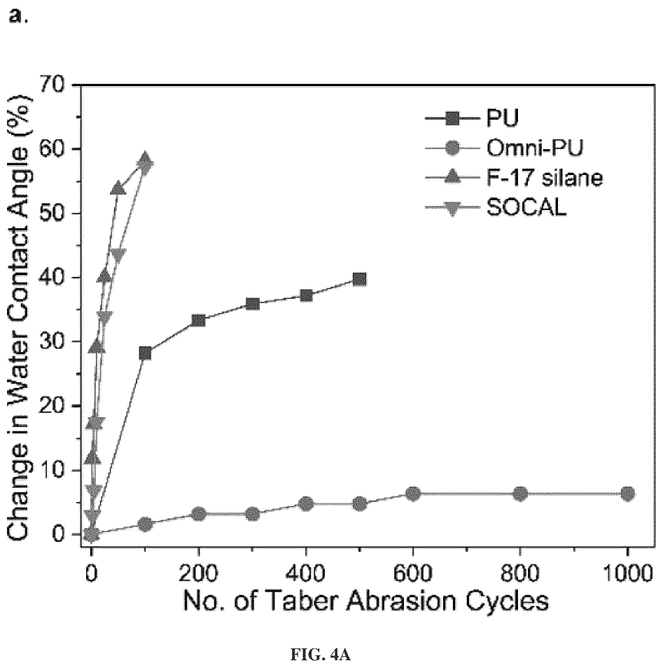

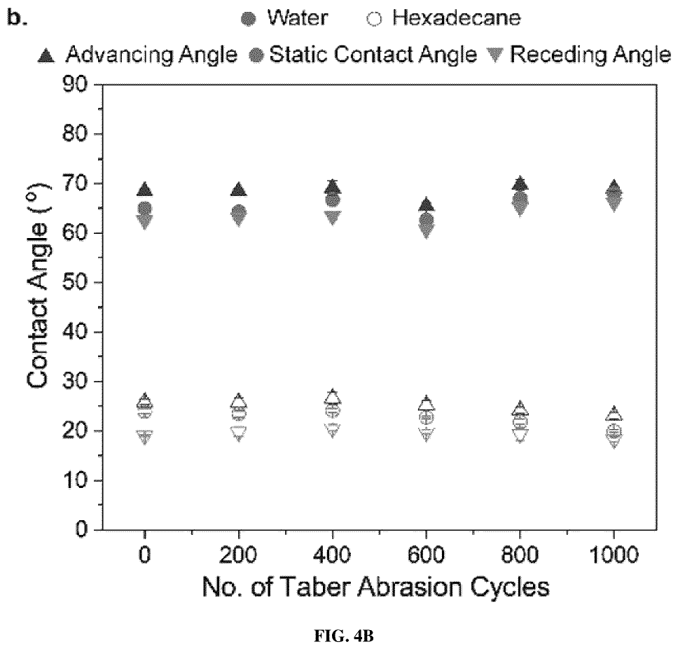

FIGS. 4A-4B demonstrate this abrasion resistance. In FIG. 4A, contact angle change of a water droplet (5 μL) on omni-PU prepared in accordance with certain aspects of the present disclosure and the control surfaces, including polyurethane, perfluorinated silanized silicon, and the slippery omni-phobic covalently attached liquid (SOCAL) coating over the Taber abrasion test. The Taber abrasion used 800-gram weight with CS-10 under 60 cycles/min linear motion. The error bar was obtained from at least 5 independent measurements. FIG. 4B shows water and hexadecane over advancing angle, static contact angle, and receding angle. It is believed that this is the first omniphobic surface demonstrating both a high mechanical durability and anti-fouling properties.

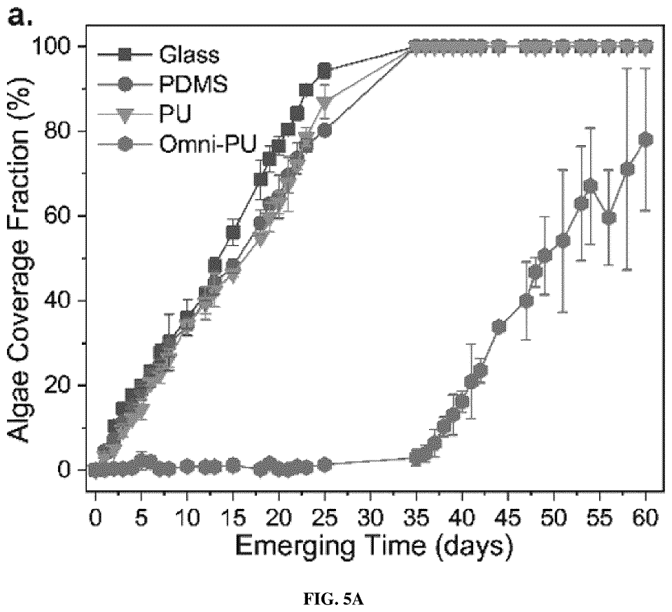

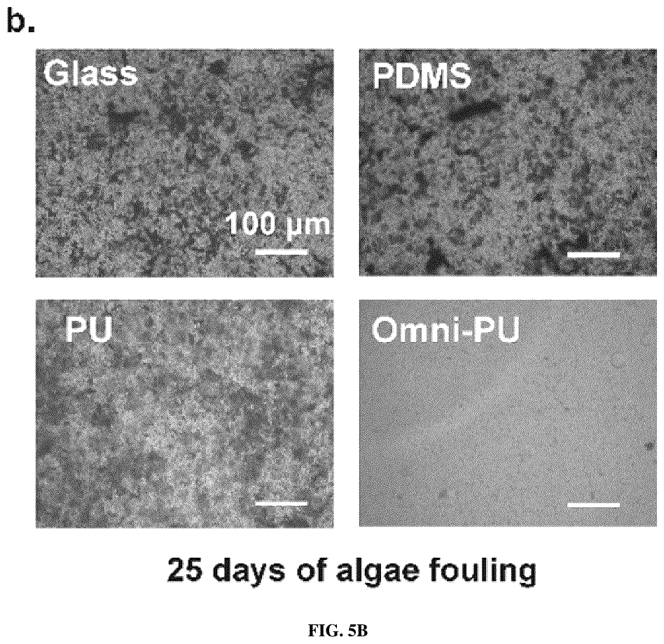

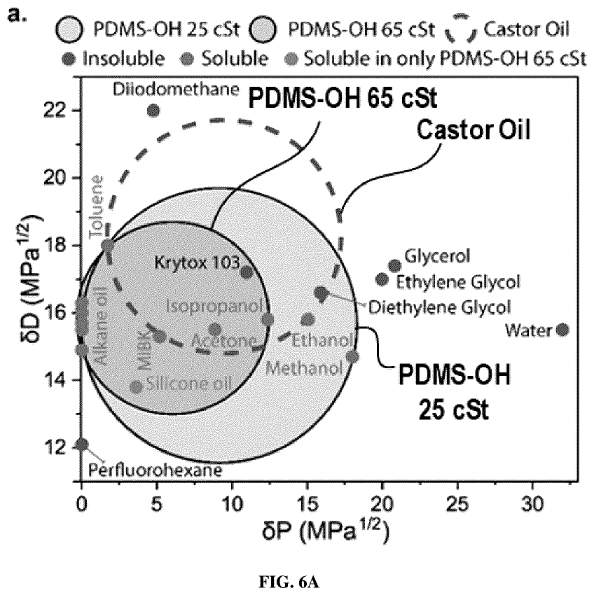

An omni-PU material prepared in accordance with certain aspects of the present disclosure is tested under a marine algae (cyanobacteria and diatom) fouling environment, which contains both soft and hard solid foulants. As shown in FIGS. 5A-5B, the omni-PU material shows anti-fouling performance over a duration of one month, while the rest of the control surfaces all fouled dramatically within 20 days, including a commercially available state-of-the-art PDMS coating. In FIG. 5A, a marine algae coverage area fraction on omni-PU and other control surfaces (polyurethane (PU), polydimethylsiloxane (PDMS, SYLGARD™184), and glass) is shown for 60 days. In FIG. 5B, optical microscopy images comparing omni-PU and other controls (PDMS, PU, and glass) after 25 days of algal fouling. The error bar was obtained from at least 3 independent measurements.

As such, the fabricated coatings are highly durable against cyclic mechanical abrasion, and can resist 10 times more abrasion cycles than currently available slippery surfaces. This outstanding durability performance of omni-PU coatings is attributed by their high hardness and the formation of a stable lubricant layer, where the lubricating domains are bound to the elastomeric matrix. By bridging the classic wetting and the tribology models, a new dimensionless design parameter (K_{AR}) is provided for creating such abrasion resistant coatings. In addition, the Hansen solubility parameters may be applied as a design framework to predict the liquid repellency of the different omni-PU coatings with greater than 80% accuracy. Finally, these omni-PU coatings are able to repel solid foulants with a wide range of modulus, from soft bacteria film to marine algae, and hard ice. This combination of mechanical durability and broad anti-fouling properties has applicability for these solid and liquid repellant materials to be used in a wide variety of industrial and medical applications, including biocompatible implants, underwater vehicles, and anti-fouling soft robotics.

In designing and fabricating mechanically durable omniphobic surfaces, the following considerations are taken. To design a wear-resistant material that can withstand mechanical abrasion, particularly for polymer coatings, the yield strength of the materials is desirably maximized; while under the same load (F_{L}), the frictional forces (F_{F}) that create wear particles by cutting need to be minimized. A classic wear model for polymers, known as the Ratner-Lancaster correlation, predicts the volume worn per sliding distance, i.e., wear rate (W_{R}) as:

$${W}_{R} = C μ / H σε \qquad ( 1 )$$

where Cis a constant, μ is the friction coefficient, His the hardness of the polymer, and σ and ε are the stress and strain at tensile break. Based on this wear model, a polymer coating with a low wear rate (W_{R}) ideally has a high yield strength and hardness, and low friction coefficient with the abrader. The friction coefficient can be reduced by introducing lubrication, which can also enhance the yield strength of the interfaces. For a lubricated surface, considering the deformation of the solid substrate in mechanical abrasion, the friction coefficient (u) based on Hardy's friction model can be expressed as:

$$μ = ( r \cdot {s}_{l} + ( 1 - r ) \cdot {s}_{m} ) / H \qquad ( 2 )$$

where r is contact area ratio of fluid lubrication, sᵢ and sₘ are the shear strength of the lubricant film and the solid substrate respectively, and H is the hardness of the solid substrate. In most cases, sᵢ is much lower in magnitude than sₘ. Therefore, the Ratner-Lancaster correlation can be modified with Hardy's friction model, and the wear rate (W_{R}) can be expressed as:

$${W}_{R} = C [ r \cdot {s}_{l} + ( 1 - r ) \cdot {s}_{m} ] / {H}^{2} σ ε \qquad ( 3 )$$

Based on this modified relation for abrasive wear on polymer coatings, a wear resistant coating satisfies two criteria: first, a polymer matrix has high hardness (i.e., increased H); and second, a stable lubricant layer and a fully lubricated state even after abrasion (i.e., maintain r approximately equal to 1).

For the hardness design criteria, there are numerous commonly used hard polymers demonstrating wear resistance, including poly (methyl methacrylate) (PMMA), polytetrafluoroethylene (PTFE), polyurethane (PU), etc. Therefore, the challenge of creating wear resistant polymer coatings is how to create and retain a stable lubrication layer even after abrasion.

Conventional lubricated surfaces are currently fabricated by two distinct methods: first, infusing a liquid lubricant into a porous matrix to form slippery liquid-infused surfaces (SLIPS); and second, covalently bonding mobile polymer brushes above their glass transition temperature onto smooth substrates, so they have an orthogonal orientation to the substrate. The lubricant infusion strategy requires the lubricant is thermodynamically stable on the porous substrates under both air and different liquid foulants. This design strategy generally cannot sustain a stable lubricant layer after fluid shear or abrasive wear. Abrasion damages these surfaces and easily exposes the unlubricated solid substrate (i.e., decrease in r), and results in an increase in the wear rate (W_{R}). For liquid-like surfaces, the polymer brushes have a thickness ranging from approximately 1 nm to less than about 10 nm depending on the chain length of the polymer. This thin coating can be easily damaged by mechanical abrasion owing to the low thickness and the softness of the coating.

In order to overcome the poor mechanical durability of conventional smooth slippery surfaces, the present disclosure provides omniphobic coatings where the lubricant is partially crosslinked between polymer matrix as shown in FIG. 1E, previously discussed above. This enables the coating to have a polymer matrix with bonded lubricant domains that maintains complete lubrication after abrasive wear, i.e., retain r at approximately 1 and a low W_{R}. In addition, this lubricant partial crosslinking can help reduce the loss of lubricant owing to the enhanced intermolecular forces between the polymer matrix and the lubricant. Consequently, it prevents the increase in W_{R} due to the lubricant loss through shear, wear, and evaporation.

Polyurethanes (PU) can exhibit high hardness (H) and wear-resistance (Modulus of about 10.35 MPa and a hardness of about 3.12 MPa), which can make polyurethanes a suitable candidate for a polymer matrix material to form fully lubricated (i.e., r approximately equal to about 1) coatings with enhanced mechanical durability. However, most commonly used lubricants have finite contact angles on polyurethane, and can only form a discontinuous lubricant layer (r<1) with reduced lubricant thickness. In other words, the physiochemical properties of the lubricant and the PU cannot satisfy the thermodynamic requirements to form a stable continuous film, which are a positive spreading parameter and a positive disjoining pressure in all lubricant thickness. This is because PU in certain variations (for example, a commercially available isocyanate (DESMODUR™ N3800)) has a surface energy of 26.71 mJ/m², with a relatively high polar surface energy as 8.18 mJ/m² and results in finite contact angles (10° to) 30° of commonly used low/non-polar lubricants, including silicone oil, hydroxy terminate polydimethylsiloxane (PDMS-OH), fluorinated PDMS diol (C7-F), castor oil, and KRYTOX™ oil. Table 1 reflects surface tension of different polyols.

TABLE 1

| | Surface Tension |
|---|---|
| Liquid | (mN/m) |
| PDMS-OH 25 cSt | 21.5 ± 0.4 |
| PDMS-OH 65 cSt | 21.8 ± 0.4 |
| C7-F | 21.0 ± 0.4 |
| Castor oil | 25.4 ± 0.4 |

Note:
The errors were obtained from at least three independent measurements.

In order to form a surface of a PU polymer matrix that exhibits full lubrication, in accordance with various aspects of the present disclosure, select polyols are partially crosslinked with the polyurethane to form a polymer layer with bound lubricating domains. In certain variations, polyols are selected from greater than or equal to 2 hydroxyl groups per molecule to partially crosslink with a tri-isocyanate. By this method, the resultant polymer matrix/layer has almost identical surface energy and other physiochemical properties to the polyol in the lubricating domains, which enables the satisfaction of the thermodynamic requirements for forming a stable lubricant layer.

Table 2 reflects the Hardness (HA) values for different polymer coatings, including control polymeric coatings and several prepared in accordance with the present teachings.

TABLE 2

| | Hardness |
|---|---|
| Polymer Coatings | (HA) |
| PDMS (SYLGARD ™ 184, 10:1) | 42 ± 2 |
| (Control) | |
| iPDMS (swelled with silicone oil 20 cSt) | 27 ± 1 |
| (Control) | |
| PU (N3800) (Control) | 61 ± 2 |
| iPU (swelled with PDMS-OH 25 cSt) | 55 ± 1 |
| (Control) | |
| Omni-PU (1:1) | 42 ± 1 |
| Omni-PU (1:1 with polyol 670BA) | 48 ± 1 |
| Omni-PU (castor oil 4:1) | 12 ± 1 |

Note:
The ratio in omni-PU indicates the polyol-to-triisonyanate weight ratio. The errors were obtained from at least 3 independent measurements.

### EXAMPLES

An omniphobic durable solid and liquid repellant material prepared in accordance with certain aspects of the present disclosure via oil infusion (hydroxy terminated PDMS) is manufactured using multiple steps. 1. Vortex mixing hydroxy terminated polydimethylsiloxane (PDMS-OH) (Sigma Aldrich) and isocyanate (Covestro, DESMODUR™ N3800) in a methyl isobutyl ketone (MIBK) (Fisher Scientific) solvent for 15 minutes until the mixture has no bubbles and is optically clear. 2. Addition of a catalyst (dibutyltin dilaurate (Fisher Scientific) 0.1 wt. % in MIBK) to the solution with a weight percentage of 2.67%, followed by 5 minutes of vortex mixing and 10 minutes of sonication to remove bubbles. 3. Heating of the solution to 90° C. in the oven for 90 minutes. 4. Drop casting or spray coating the solution onto surfaces with functional groups (—NH₂) that are prepared before the coating process. Surface hydroxylation was performed using an oxygen plasma exposure for 15 minutes with a power of 40 W. Amine surface functionalization on glass was performed through the following process: the glass surface was exposed to an oxygen plasma for 15 minutes with a power of 40 W. Then the glass was placed into a solution of 2 wt. % bis(3-trimethoxysilylpropyl) amine (Gelest Inc.) in ethanol (12.5 mL ethanol, 195 μL silane, 0.63 mL of pH=2 acetic acid solution; stirred for 2 h before use) for 20 min. 5. The coating was cured in a vacuum oven at 40 to 60° C. for maximum 2 days. 6. Post-annealing of the coating was performed on a hot plate at a temperature of 60-75° C. for a maximum 1 day. Note: The tri-isocyanate used here is highly sensitive to moisture. If the coating solution was cured under high humidity, the isocyanate would simultaneously react with moisture, resulting in strong phase separation and poor liquid repellency and transparency).

Hardness measurement: A digital shore hardness tester was used to measure the hardness of the fabricated elastomeric coatings. All coatings were greater than 6 mm in thickness and greater than 24 mm in diameter as required by the hardness tester. Before the measurement, the hardness tester was calibrated by a clean glass slide with a reading of 100 H. All samples were placed on glass slides, followed by perpendicularly pressing the indenter tip onto the surfaces until the pressure plane conformally contacting the surfaces. After holding the indenter tip for greater than 1 second, the reading from the digital shore hardness tester was the hardness of the sample. As the hardness tester required, all samples were kept at room temperature for greater than 5 hours before the measurement, and the measurement were taken at room temperature as well.

Hanson solubility analysis: The polar (δP) solubility parameters were the quadratic means of the corresponding dipolar (δp) and the hydrogen (δh) solubility parameters, and the dispersion (δD), the dipolar (δp), the hydrogen (δh) solubility parameters were obtained from the Hansen Solubility Handbook. 1 mL of each polyol (PDMS-OH 25 cSt, PDMS-OH 65 cSt, castor oil, C7-F) were slowly added to 17 different testing solvents (mixing ratio 1:1 in volume), including acetone, dodecane, ethanol, ethylene glycol, hexane, methanol, octane, hexadecane, perfluorohexacene, toluene, water, decane, glycerol, silicone oil with a viscosity of 20 cSt, VERTREL™ XF, isopropanol, and methyl isobutyl ketone (MIBK). The immediate mixing of two liquids was considered fully soluble, while the well mixing after 5 minutes of sonication was considered soluble. The obvious separation of two liquids after 5 minutes of sonication was considered insoluble. For Hansen solubility analysis through the software, the insoluble solvents were labeled with 0, and the soluble solvents were labeled with 1.

Materials and fabrication of control surfaces: The control surfaces include glass, PDMS, PU, iPDMS, iPU, SOCAL, and F-17. The glass was a microscope glass slide from Fisher Scientific. The PDMS was SYLGARD™ 184 (10:1) from Dow Inc. The PDMS was cured in an oven at 80° C. for 24 hours. The PU was DESMOPHEN™ N3800 from Covestro. The PU was cured in ambient air. iPDMS was fabricated by swelling PDMS (SYLGARD™ 10:1) in silicone oil (20 cSt, Sigma Aldrich) at 60° C. for 24 hours. The iPU was made by submerging PU in PDMS-OH 25 cSt at 60° C. for 24 hours.

Measurement of free polyol in the elastomeric layer: The free polyol in the elastomeric layer/omni-PU coating was extracted by soaking the films multiple times in toluene for a duration of 24 hours. After each solvent extraction, the samples were weighed by an analytical balance with a resolution of 0.1 mg. The solvent extraction experiments were continued until the mass of the sample did not change by more than 0.2 mg (considered as error). Therefore, the difference in total mass different before and after solvent extraction represents the free polyol content. Because each sample has a different initial weight, the free polyol percentage was calculated as the ratio of the weight of free polyol and the omni-PU.

Contact angle measurements: Contact angle measurements were performed with a Rame-Hart 200-F1 contact angle goniometer using the sessile drop method. Advancing and receding contact angles were obtained by measuring the angle while the liquid was slowly added to or removed by a microsyringe from a ˜5 L droplet in contact with the surface.

Algal fouling experiments: 1 gram of algae biofilm was introduced into a petri dish (diameter: 100 mm) with 50 ml of seawater and an F/2 (purchased from Amazon.com) mixture. Samples were submerged into the algae culture environment and monitored by using a Nikon optical microscope every day. The area fraction was quantified with microscopic images of the samples through ImageJ analysis as previously reported. The microscope images were taken on at least 3 different locations for each of the sample surfaces.

Ulva spores fouling: Ulva fasciata was used in the single-species fouling tests. The omni-PU (polyol-and-isocyanate ratio: 2:1) and the control surfaces (polystyrene) were submerged in a solution (50 mL) with 1 gram of Ulva larvae. The Ulva were not provided with any nutrients for 2 weeks, which caused them to release their spores. Then a culture solution containing nutrients was re-introduced back into the fouling environment. After 3 days, the spores settled on the surfaces and started to grow. An optical microscope was used to observe the fouling status on the omni-PU and the control surfaces.

Ice adhesion strength measurement: The ice adhesion strength was measured using a customized setup, as reported previously in K. Golovin, et al., Science Advances, 2, e1501496 (2016). Specifically, an Imada force gauge with a resolution of 0.1 N was mounted on a movable stage with controlled linear speed. The gauge provided a lateral force to the ice cube, which was adhered to the substrate on top of a Peltier plate. The ice cube dimensions were ˜10×10×10 mm3, and the gauge probe contacted on the center of the ice cube sidewall. The Peltier plate was maintained at −15° C. Deionized water was used for all tests to form the ice cubes. Surfaces were allowed sufficient time to fully freeze before testing.

### Design of Liquid Repellency for Liquid and Solid Repellant Coatings

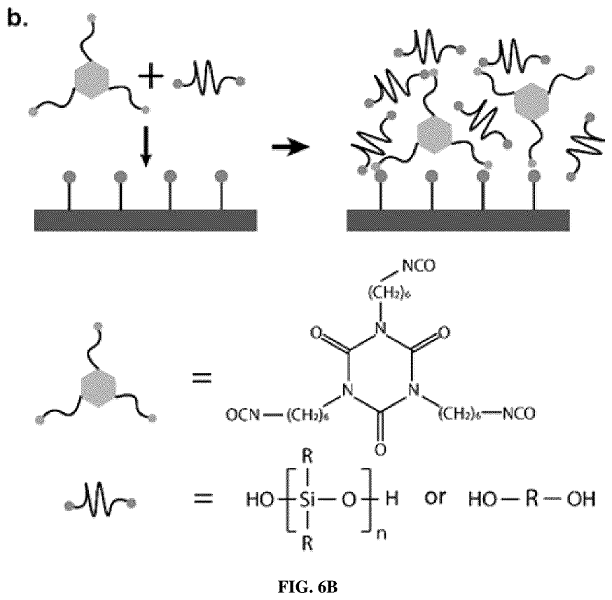

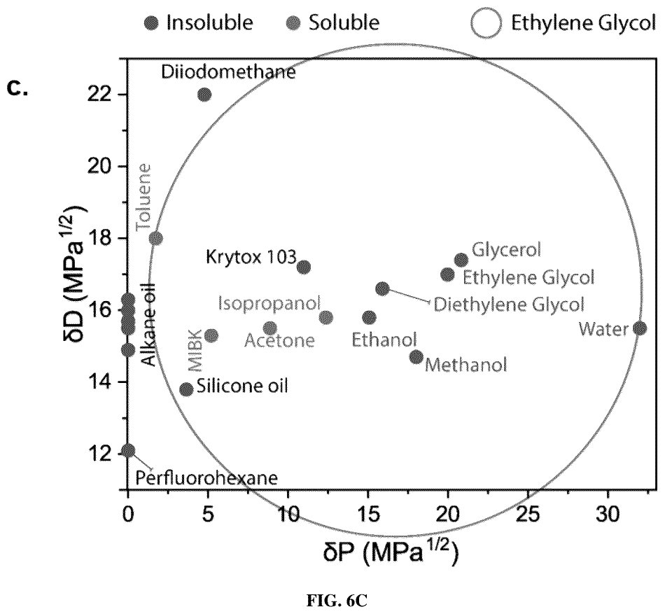

In this example, the liquid repellency of the hard PU base (elastomeric) layer with complete lubrication (omni-PU) is determined by its immiscibility with different contacting liquids. As the isocyanate molecules have been crosslinked in the polymer matrix, the solubility of different polyols to a number of common polar and nonpolar liquids with a surface tension spanning from ˜10 mN/m to 72 mN/m is investigated. Based on the solubility tests (see Table 3), Hansen solubility circles for the polyols were formed by the dispersion (δD) and the polar (δP) solubility parameters of the testing liquids as shown in FIG. 6A.

TABLE 3

| | PDMS-OH | PDMS-OH | | |
|---|---|---|---|---|
| Solvent | 25 cSt | 65 cSt | Castor Oil | C7-F |
| Acetone | Yes | Yes | Yes | Yes |
| Dodecane | Yes | Yes | No | Yes |
| Ethanol | Yes | No | Yes | Yes |
| Ethylene glycol | No | No | No | No |
| Hexane | Yes | Yes | No | Yes |
| Methanol | Yes | No | No | No |
| Octane | Yes | Yes | No | Yes |
| Hexadecane | Yes | Yes | No | No |
| Perfluorohexane | No | No | No | No |
| Toluene | Yes | Yes | Yes | Yes |
| Water | No | No | No | No |
| Decane | Yes | Yes | No | Yes |
| Glycerol | No | No | No | No |
| Silicone oil 20 cSt | No | Yes | No | Yes |
| Isopropanol | Yes | Yes | Yes | Yes |
| Methyl isobutyl | Yes | Yes | Yes | Yes |
| ketone | | | | |

The Hansen solubility circles in FIG. 6A are defined as the minimal circular area that can cover all soluble liquids to the corresponding polyols. This definition indicates that the Hansen solubility circle works to predict the solubility of untested liquids towards the selected polyols and the repellency range of the omni-PU formed by the different polyols. For example, the hydroxy terminated PDMS with a viscosity of 25 cSt (PDMS-OH 25 cSt) has the light blue solubility circle (shown in FIG. 6A), illustrating that it is miscible with polar alcohols including ethanol and methanol. This predicts that the omni-PU with PDMS-OH 25 cSt cannot repel ethanol and methanol, as shown in Table 4 below. If these alcohols need to be repelled, then PDMS diols with a higher molecular weight should be used as the reactive oil, such as PDMS-OH 65 cSt, as shown in the light red solubility circle in FIG. 6A with a repellency to the specific liquids needed to be repelled.

Table 4 provides the wettability characterization (advancing and receding contact angles) of omni-PU with different polyols prepared in accordance with certain aspects of the present disclosure.

TABLE 4

| | PDMS-OH | PDMS-OH | | |
|---|---|---|---|---|
| Probe Liquid | 25 cSt | 65 cSt | C7-F | Castor Oil |
| Acetone | 24 ± 1°/0° | 30 ± 1°/0° | 12 ± 1°/0° | Spread |
| Hexane | 9 ± 1°/0° | 8 ± 1°/0° | 9 ± 1°/0° | Spread |
| Decane | 11 ± 1°/0° | 13 ± 1°/0° | 13 ± 1°/0° | Spread |
| Dodecane | 13 ± 1°/0° | 16 ± 1°/0° | 11 ± 1°/0° | Spread |
| Hexadecane | 21 ± 1°/ | 15 ± 1°/ | 13 ± 1°/ | 8 ± 2°/ |
| | 20 ± 1° | 11 ± 1° | 11 ± 1° | 7 ± 2° |
| Silicone oil 20 | Spread | Spread | Spread | Spread |
| cSt | | | | |
| Perfluorohexane | 10 ± 1°/ | 10 ± 1°/ | 10 ± 1°/ | Spread |
| | 8 ± 1° | 9 ± 1° | 8 ± 1° | |
| Methanol | 9 ± 1°/0° | 16 ± 1°/ | 24 ± 1°/ | Spread |
| | | 13 ± 1° | 21 ± 1° | |
| Ethanol | 8 ± 1°/0° | 13 ± 1°/ | 7 ± 1°/0° | Spread |
| | | 10 ± 1° | | |
| Isopropanol | Spread | 10 ± 1°/0° | 9 ± 1°/0° | Spread |
| Ethylene Glycol | 55 ± 1°/ | 41 ± 1°/ | 26 ± 1°/ | 27 ± 1°/ |
| | 54 ± 1° | 38 ± 1° | 23 ± 1° | 25 ± 1° |
| Glycerol | 67 ± 1°/ | 80 ± 1°/ | 72 ± 1°/ | 30 ± 1°/ |
| | 65 ± 1° | 78 ± 1° | 70 ± 1° | 27 ± 1° |
| Toluene | 22 ± 2°/0° | 25 ± 1°/0° | 24 ± 1°/0° | Spread |
| Water | 72 ± 1°/ | 88 ± 1°/ | 79 ± 1°/ | 35 ± 1°/ |
| | 71 ± 1° | 85 ± 1° | 78 ± 1° | 33 ± 1° |

Note:
The bonded advancing and receding angles indicate the liquid repellency, otherwise they indicate the displacement from the probe liquids. The spread of the probe liquid only indicates the contact angles were 0° and does not mean the liquid displaced the polyol lubricant layer. The errors were obtained from at least three independent measurements.

This solubility design framework thus provides the ability to choose appropriate polyols to form the durable solid and liquid repellant material (e.g., slippery omni-PU) coatings prepared in accordance with certain aspects of the present disclosure that can repel any specific contacting liquids as needed for a specific application. In accordance with certain durable liquid-and-solid repellent coatings prepared in accordance with the present disclosure, the polyols are selected to have small solubility circles as well as to be able to form mechanically durable polymer matrix, for example, with isocyanate. For example, ethylene glycol has a solubility circle shown in FIG. 6C that is much larger than the polyols shown in FIG. 6A, making it not useful to form omni-PU surfaces according to certain aspects of the present disclosure. Another example is castor oil shown in FIG. 6A. It can be used as a polyol to form omni-PU surfaces, but the resultant omni-PU surfaces are not as mechanically durable (hardness: 12 HA), as other options. However, it should be noted that hard and durable omni-PU surfaces can be formed by using a different isocyanate with castor oil. For other applications, polyols with specific physiochemical properties can be selected, for example, conductive polyols for flexible electronics, thermal responsive polyols for energy engineering, antimicrobial polyols for biomedical applications, and more.

### Fabrication and Liquid Repellency for Coatings

Based on solubility design guidelines described above, a number of polyols (PDMS-OH 25 cSt, PDMS-OH 65 cSt, fluorinated PDMS diol (C7-F), and castor oil) are reacted with the isocyanate (DESMODUR™ N3800) to form a base polymer matrix, leaving the unreacted free polyol molecules as a lubricant distributed internally as well as on top of the polymer layer. In this example, all the polyols are partially crosslinked with the isocyanate and form hard omni-PU films, except for the castor oil, which resulted in a soft polymer film. PDMS-OH 25 cSt is selected as a representative polyol to demonstrate the synthesis of an omni-PU in accordance with the present teachings, and is further characterized by its physical properties and performance including wettability, mechanical durability, and anti-fouling. Specifically, to mix and react the polyol and the isocyanate, Hansen solubility analysis is performed methyl isobutyl ketone (MIBK) is identified as an appropriate solvent to well mix PDMS-OH 25 cSt and isocyanate, as both the components are fully miscible in MIBK. The optimal curing conditions for the PDMS-OH 25 cSt and isocyanate was are determined through Fourier-transform infrared spectroscopy (FTIR) analysis by varying the amount of catalyst present and the reaction temperature (20° C. to 100° C.). With the solvent and the curing conditions determined, a fabrication process for the omni-PU was developed to be a single-step polymer coating that could be applied and cured on a variety of substrates as shown in FIG. 1C.

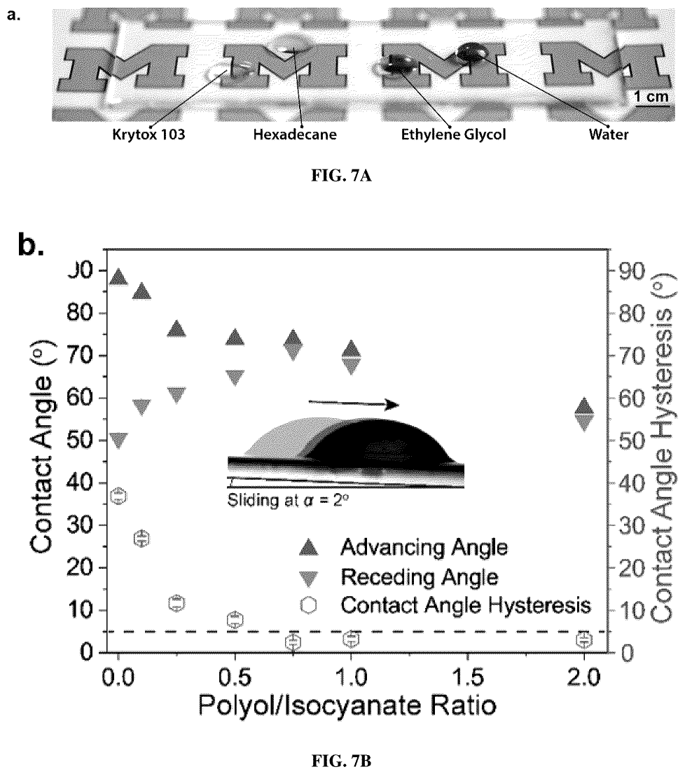

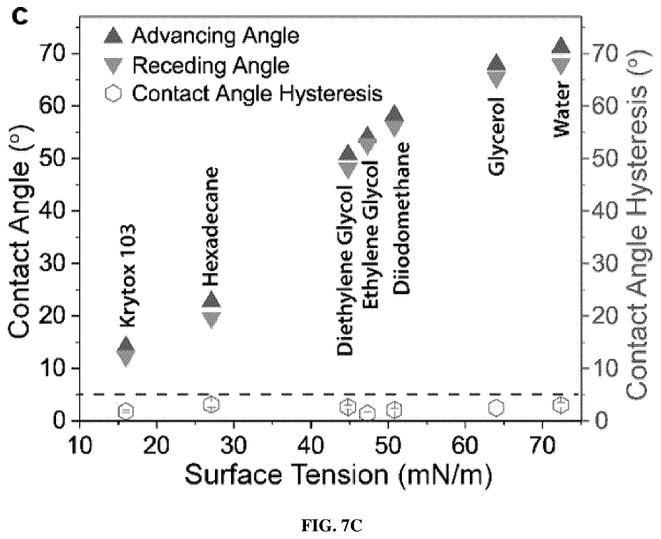

Using this fabrication process, the resultant omni-PU coating was highly transparent, with an optical transmittance of greater than 90% across the visible wavelength range. The coating also repelled liquids with a wide range of surface tensions (FIGS. 7A and 7C), where the coating repels KRYTOX™ 103, hexadecane, ethylene glycol, and water. In addition, the percent of premixed polyol content in the coating solution was systematically altered, so that it was determined that a weight ratio between the polyol and the isocyanate is desirably greater than or equal to about 0.75 in order to achieve strong liquid repellency, i.e., an ultra-low contact angle hysteresis) (<5° to foreign liquids that are outside the corresponding solubility circle of the polyol (FIG. 7B). The free polyol molecule percentage in omni-PU varies with the premix ratio of the polyol and the isocyanate. For example, a 2:1 weight ratio of the polyol and the isocyanate results in approximately 20. Wt. % of free oils inside and on top of omni-PU film. Table 5 shows free polyol weight percentage in an omni-PU coating with different premixing ratio of polyol and isocyanate.

TABLE 5

| | Polyol:Isocyanate Ratio | | | | |
|---|---|---|---|---|---|
| | 0.1 | 0.25 | 0.5 | 1 | 2 |
| Free polyol wt. % | 0.08 | 0.14 | 0.35 | 0.53 | 21.4 |

Note:
The polyol was PDMS-OH 25 cSt, and the tri-isocyanate was DESMOPHEN ™ N3800 from Covestro.

As predicted by the Hansen solubility design framework for the PDMS-OH 25 cSt, the omni-PU elastomeric layer with a polyol-isocyanate ratio of 2:1 exhibits liquid repellency towards a range of high surface tension (water: 72.4 mN/m) and low surface tension liquids including fluorinated liquids such as perfluoropolyether (PFPE: 16 mN/m) with low contact angle hysteresis (less than about) 5° (FIG. 7B). This example shows that the Hansen solubility design framework has a greater than 80% accuracy (e.g., 3 exceptions in 17 testing solvents) in predicting the liquid repellency for omni-PU with PDMS-OH 25 cSt. For example, the Hansen solubility parameters of KRYTOX™ oil and hexadecane are inside the solubility circle of the PDMS-OH 25 cSt, but they can be repelled by omni-PU. The mechanisms of the repellency towards these two liquids are different. For KRYTOX™ oil, it is not soluble with PDMS-OH 25 cSt in the solubility testing described above, although its Hansen solubility parameters fall into the solubility circle. While for hexadecane, it is soluble with PDMS-OH 25 cSt only after sonication. The contacting time in the contact angle measurement of hexadecane on omni-PU surfaces was short to avoid the mixing of these two liquids. For applications that do not require optical transparency, the isocyanate can be reacted with multiple immiscible polyols as well (e.g., PDMS-OH and polyol (Covestro, Desmophen 670BA)) to form omni-PU. Such a system is opaque, but it can maintain a stable lubrication layer and demonstrates the same liquid repellency performance as the transparent polyol omni-PU systems.

### Mechanical Durability of Liquid and Solid Repellant Coatings

### Mechanical Abrasion Test

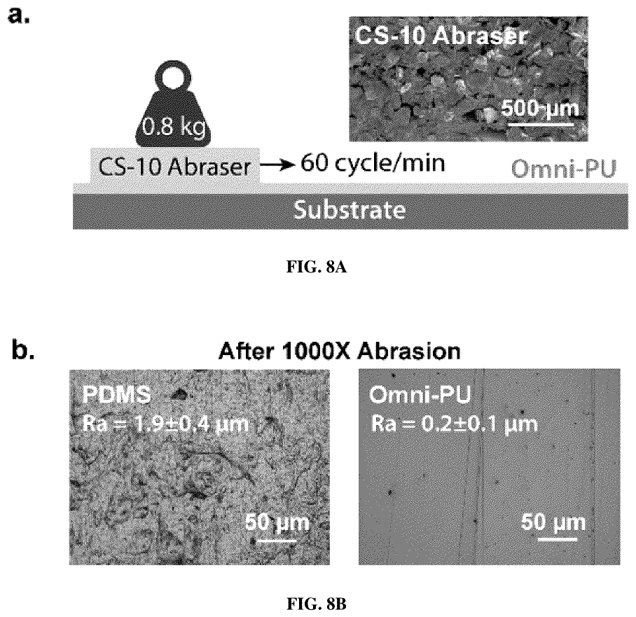

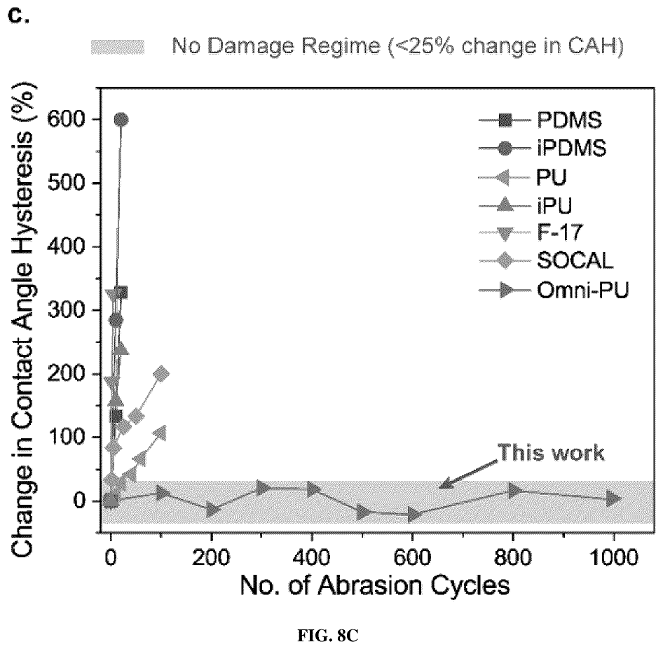

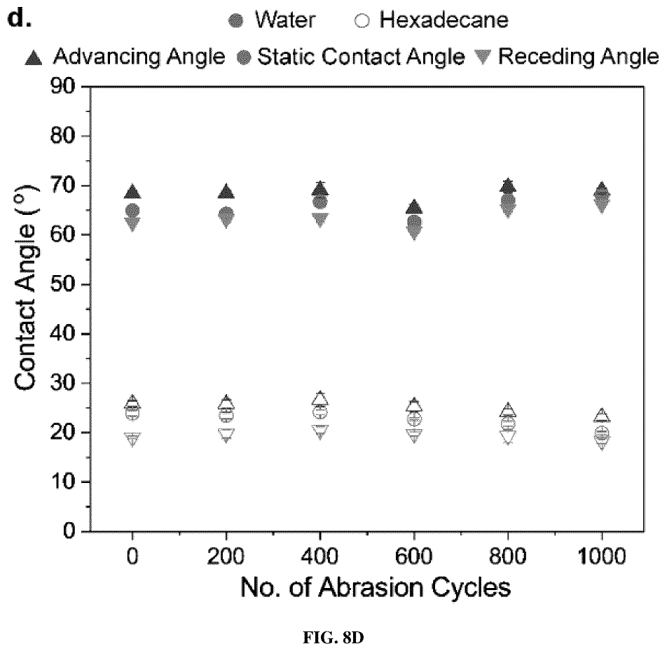

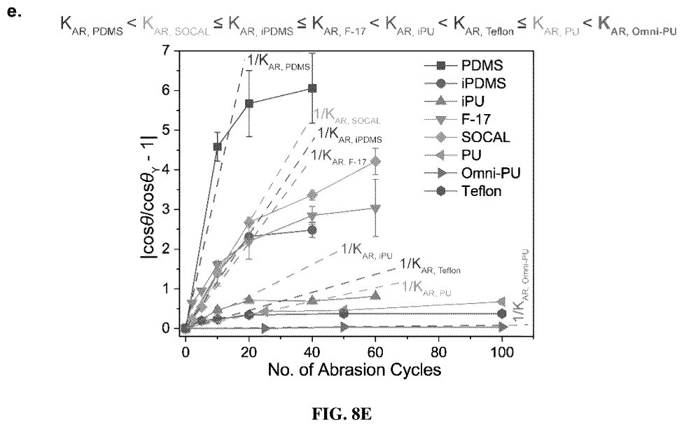

To test the mechanical durability of the omni-PU elastomeric layer coating, Taber abrasion tests are conducted with linear reciprocating motion (60 cycles/min with 100 mm travel distance per cycle) using a harsh abrasion surface (CS-10: Al₂O₃ particles embedded in rubber) and pressure (1000 grams loading weight) as shown in FIG. 8A. The durable polyurethane (DESMODUR™) can withstand greater than 1,000 cycles of these mechanical abrasion conditions with minimal weight loss (less than 0.2 wt. %), while the soft PDMS (SYLGARD™184 10:1) decreased by about 5% in weight after the same abrasion process. Owing to the lubrication of omni-PU, the wear resistance of the material is further enhanced compared to the PU surface. Optical microscopy analysis of the omni-PU and the control surfaces (i.e., PDMS, PDMS swelled with silicone oil (iPDMS), PU, PU swelled with PDMS-OH (iPU) and detailed fabrication of control surfaces discussed above demonstrated significant differences before and after abrasion. Obvious scratches and surface roughening were observable after mechanical abrasion of the control surfaces. In contrast, the omni-PU surface prepared in accordance with certain aspects of the present disclosure showed only a few shadow scratches, and the rest of the surface remained smooth.

In addition, based on the roughness measurements through Zygo optical profiler before and after abrasion (FIG. 8B and Table 6), the omni-PU surfaces showed a mild change (<5 times increase) in surface roughness while the roughness on the control materials, particularly PDMS, increased by a factor of up to 50 after the mechanical abrasion. Table 6 shows surface roughness of different polymer coatings before and after abrasion.

TABLE 6

| | Before Abrasion | 100× Abrasion | 1000× Abrasion |
|---|---|---|---|
| PDMS | 41 ± 3 nm | 1153 ± 16 nm | 1914 ± 424 nm |
| iPDMS | 25 ± 18 nm | 748 ± 50 nm | 1260 ± 70 nm |
| PU | 26 ± 14 nm | 33 ± 8 nm | 106 ± 15 nm |
| iPU | 13 ± 9 nm | 194 ± 76 nm | 279 ± 136 nm |
| Omni-PU | 29 ± 18 nm | 135 ± 2 nm | 195 ± 64 nm |

Note:
The roughness was measured by Zygo optical profiler with a z-axis resolution of 1 nm. The errors were collected from at least 4 independent measurements.

Therefore, the omni-PU is approximately 10 times more resistant to increases in roughness than PDMS.

Furthermore, contact angle and contact angle hysteresis measurements are performed on a group of conventional polymer coatings and omni-PU coatings prepared in accordance with certain aspects of the present disclosure after various mechanical abrasion cycles are tested with results shown in FIGS. 8C-8E. The contact angle hysteresis of all the control materials in this example, including PU, PDMS, perfluorinated silanized silicon (F-17), PDMS brushes (SOCAL), iPDMS, and iPU, increased by a factor of 100% to 600% after 100 cycles of abrasion, when compared to the undamaged surfaces (FIG. 8C). On the other hand, the omni-PU maintains its low contact angle hysteresis with minimal changes (less than about 25%) after 1,000 cycles of mechanical abrasion under the same conditions (FIGS. 8D-8E). Therefore, the inventive omni-PU outperforms all state-of-the-art liquid repellent surfaces in the mechanical abrasion tests, retaining the liquid repellency under an order of magnitude more abrasion cycles.

The poor mechanical durability of the currently available anti-fouling surfaces is attributable to two distinct mechanisms. For the different polymer coatings (e.g., PU and PDMS), the increase in contact angle hysteresis can be mainly attributed to the increase in surface roughness. The random surface features generated by abrasion results in the formation of the Wenzel state for water droplets on the surface. Owing to the contact line pinning at these random micro/nano-features, the receding angle of the water droplets decreases, and the contact angle hysteresis increases on the abraded polymer coatings. For surfaces functionalized with polymer brushes (e.g., SOCAL), the thin (less than about 10 nm) polymer layer was partially removed by mechanical abrasion, exposing the underlying hydrophilic substrate. This resulted in a significant decrease in both the advancing and receding contact angle.

### Abrasion Resistant Parameter

To further characterize the impact on the liquid repellency of surface coatings from abrasive wear, the Wenzel model was applied to characterize how the wear rate (i.e., worn volume per sliding distance) impacts surface properties (e.g., roughness and wetting). Specifically, the newly generated surface area (ΔA) from abrasive wear can be quantified by using the Wenzel relation as:

$$Δ A = ( cos θ - cos {θ}_{Y} ) R {L}_{0} / cos {θ}_{Y} \qquad ( 4 )$$

where θ is the water contact angle after abrasion, θ_{Y} is the Young contact angle of water on the smooth surface, R is the radius of abrasion tool, and L₀ is the sliding distance of the abrader in one cycle. Based on previous studies, the wear volume is dependent on the size of particles embedded in the abrader when the particle size is below 100 μm. Therefore, the wear volume can be expressed as:

$$Δ V ∝ N \cdot {L}_{0} \cdot R \qquad ( 5 )$$

where R is the average radius of the embedded particles in the abrader.

For a smooth surface, Taber abrasion will generally result in a rougher surface. Particularly in early cycles of abrasion using CS-10 abrader (i.e., ceramic particles embedded rubber), obvious groovy scratches were created on the different surfaces. These scratches can be estimated in cuboid shapes. In Taber abrasion, particularly when using ceramic particles embedded rubber as the abrader (e.g., CS-10 abrader), the newly generated surface area (AA) can be expressed as: ΔA∝ΔV, specifically, ΔA∝L₀·N·W_{R}.

By combining the Wenzel model and the modified Ratner-Lancaster correlation (i.e., Equation 3), the correlation between abrasive wear and surface wetting, i.e., (cos θ*/cos θ−1)∝N/K_{AR} can be found, where N is the cycle number of the abrasion. K_{AR} is thus introduced as the dimensionless abrasion resistance parameter of the material:

$${K}_{AR} = \frac{{H}^{2} ε σ}{r \cdot {s}_{l} + ( 1 - r ) \cdot {s}_{m}} \qquad ( 6 )$$

The higher the value of K_{AR}, the more durable the coating.

### Experimental Abrasion Resistant Parameter

By using the receding contact angle after abrasion as the apparent contact angle (θ) and the receding contact angle before abrasion as the Young contact angle (θ_{Y}), the correlation between |cos θ/cos θ_{Y}−1| and the abrasion cycle number (N) can be plotted as shown in FIG. 8E. Because the testing surfaces were smooth with a roughness under 50 nm, the water receding contact angle on non-abraded surfaces was estimated as the Young contact angle. In addition, receding contact angle is used as the contact angle in the Wenzel or the Cassie-Baxter relations after abrasion. From FIG. 8E, the value of |cos θ/cos θ_{Y}−1| changes linearly within the initial abrasion cycles and approaches a plateau value after continuing abrasion cycles. While not limiting to any particular theory, it is hypothesized that the linearly increasing regime of |cos θ/cos θ_{Y}−1| is a result of the increased surface roughness generated by the abrasion. The plateau regime reflects the point when abrasive wear on the surface occurs mainly between the abrader and the debris from the removed materials. Therefore, the slope of the linear increase in the value of |cos θ/cos θ_{Y}−1| with cycle number is the reciprocal of the abrasion resistance parameter (1/K_{AR}) (FIG. 8E).

Specifically, a steeper slope indicates the materials are less abrasion resistant and can be more easily mechanically damaged. It is observed in FIG. 8E that the inventive omni-PU has the lowest slope and therefore, it is the most mechanically durable material tested, compared to state-of-the-art polymer coatings. The omni-PU has the largest abrasion resistance parameter (K_{AR} of approximately 1,000). In addition, from FIG. 8E, the iPDMS is much more durable than the PDMS as the lubrication increases K_{AR} (approximately 8) with the decrease on friction coefficient (u) and a similar hardness (H). Interestingly, the iPDMS and SOCAL (PDMS-brushed) surfaces have similar K_{AR} values, which indicates their “liquid-like” properties reported in the literature. In addition, partially lubricated iPU has a lower K_{AR} value (approximately 11) than non-lubricated PU (approximately 40). This is because the change in receding contact angle is a result of the increase in surface roughness as well as the removal of the lubricant on iPU (i.e., lower Co compared to homogenous coatings).

### Solid Repellency of Coatings

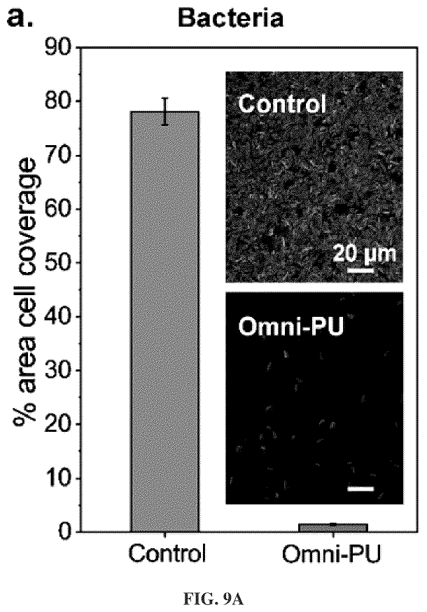

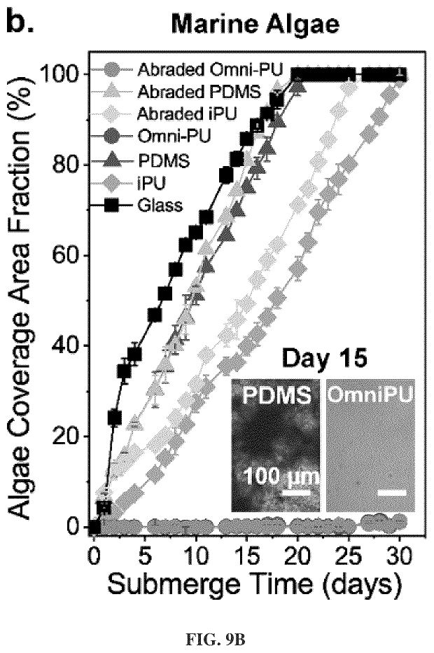

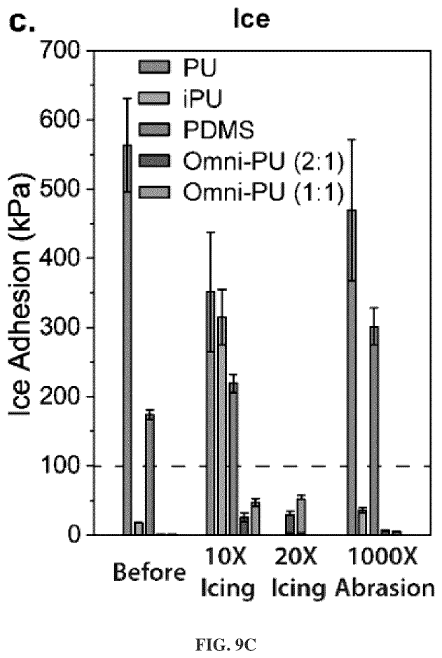

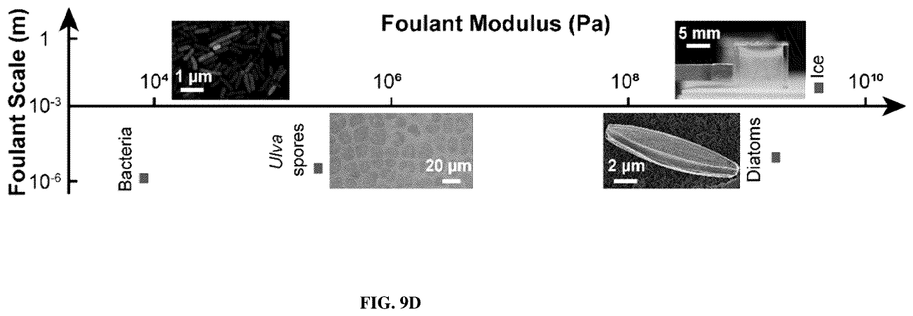

In addition to liquid repellency, the solid repellency of omni-PU coatings prepared as described above is tested against infectious bacteria (E. coli.), soft marine foulants (cyanobacteria and diatom), and ice. FIGS. 9A-9D. Inventive examples of omni-PU surfaces were fabricated with an oil-isocyanate ratio of 2:1 and were compared to unmodified PU surfaces as the control. To test bacterial adhesion, these two surfaces were exposed to the liquid culture of the genetically modified E. coli with green fluorescent protein for 24 hours at room temperature, conditions which allow for biofilm formation. After gently rinsing with 1× phosphate buffered saline for three times, the attached bacteria/biofilms were fixed with a 5% glutaraldehyde solution for 40 minutes before analysis in a fluorescent microscope. The fluorescent images in FIG. 9A compare the adhered E. coli coverage on the omni-PU and the control surfaces. Less than 3% of the area on the omni-PU samples were covered with E. coli biofilm, while approximately 80% of the area on the control surface was covered with biofilms. Thus, due to the presence of a robust lubrication layer (e.g., the ultra-low adhesion of bacteria cells and biofilms on the stable lubrication layer), the omni-PU surfaces are highly efficient in preventing fouling from E. coli.

In testing for evaluating marine algae fouling, omni-PU was compared to a range of control surfaces (PDMS, iPU, and glass), both before and after 1,000 cycles of Taber mechanical abrasion. Following previously reported procedures in J. Wang, et al., Advanced Materials Interfaces, DOI 10.1002/admi.2020006722000672 (2020), the samples were submerged into the algae culture solution, and the areal coverage that was covered by algae (algae coverage area fraction in FIG. 9B was quantified with optical microscopy every day for 30 days. The marine algae culture contained both soft (e.g., cyanobacteria) and hard (e.g., diatoms) solid foulants, with a range in elastic modulus from 10 kPa to 106 kPa. Both the abraded and the non-abraded omni-PU surfaces exhibited anti-fouling performance over a duration of one month, outperforming the rest of the control surfaces, which were all fouled dramatically within 20 days (100% coverage for PDMS and glass, and approximately 60% coverage for iPU) FIG. 9B. (This antifouling performance is better than nanostructured superhydrophobic surfaces under the same algal fouling conditions (23 days), as well as slippery liquid-infused porous surfaces under similar marine fouling conditions (Ulva linza spores, 8 days). This excellent anti-fouling capability of omni-PU is attributed to the self-regeneration and the low algae adhesion of the PDMS-OH complete lubrication layer, which serves to continually minimize or prevent any attached marine microspecies. In addition, the abraded PDMS and iPU coatings experienced more fouling than their non-abraded surfaces. This is because the abrasion increased the surface roughness on PDMS (approximately 50 times) and iPU (approximately 20 times), resulting in more contact area for algae to settle and grow. In contrast, the mechanical abrasion had a limited impact on the algal fouling on the omni-PU surfaces since the surface roughness only increased by approximately 5 times and the coating remained completely lubricated. Furthermore the fouling using a single-species solution containing Ulva spores (modulus: approximately 0.1 MPa) was tested on an omni-PU and control surface as described above. The Ulva spores preferred to settle on the control surface instead of omni-PU surface. Without limiting the present teachings to any particular theory, it is hypothesized that the PDMS-OH layer on omni-PU could influence the mechanosensing ability of the Ulva spores, and enabled the anti-fouling of omni-PU surfaces towards Ulva spores.

To study ice adhesion, the omni-PU surfaces with varying polyol-to-isocyanate ratios (1:1 and 2:1) were compared with a range of control surfaces (PU, iPU, and PDMS) using a previously published ice cube adhesion test. “Icephobic” surfaces generally have an ice adhesion strength below 100 kPa (the dashed line in FIG. 9C). From FIG. 9C, before any cyclic abrasion testing, the lubricated surfaces were icephobic with an ice adhesion strength less than about 30 kPa, while the dry polymer coatings were not icephobic and had much higher ice adhesion strengths (up to 560 kPa). to further explore the icephobic performance of the omni-PU surfaces, we performed two durability tests on these samples: 1) multiple icing and deicing cycles; and 2) ice adhesion after Taber mechanical abrasion. Specifically, 10 icing and deicing cycles are performed on the omni-PU and the control surfaces, and measured the ice adhesion strength after each cycle (FIG. 9C). The dry polymer surfaces (i.e., PDMS and PU) retained their high adhesion strength to the ice throughout the testing. The lubricant layer on the iPU surfaces was almost completely removed by 10 icing cycles, resulting in a significant increase in ice adhesion strength from less than 30 kPa to greater than 300 kPa. In comparison, the stable lubrication provided by omni-PU according to certain embodiments of the present disclosure was maintained after 10 cycles of the icing-and-deicing, and the surface remained icephobic with an ice adhesion strength below 50 kPa. Further, 20 icing-and-deicing cycles were performed on omni-PU surfaces with different polyol-to-isocyanate ratios (1:1 and 2:1). The ice adhesion strength on these surfaces gradually increased to and stayed at 33 kPa and 51 kPa on omni-PU with 2:1 and 1:1 polyol-to-isocyanate ratio, respectively. This indicates that these surfaces transitioned from a hydrodynamic lubrication film to interfacial slippage during 20 cycles of icing-deicing, and can remain icephobic after up to 50 icing-deicing cycles.

To study the influence of abrasion on anti-icing performance, the ice adhesion strength on these surfaces after 1,000 cycles of Taber mechanical abrasion is measured. As shown in FIG. 9C, the ice adhesion did not change significantly and remained high (approximately 500 kPa) on PU, because it is relatively mechanically durable. On the softer PDMS surface, the mechanical abrasion increased the surface roughness by 2 orders of magnitude (Table 6). As a result, the ice adhesion strength on the abraded PDMS increased by almost 2 times, from approximately 170 kPa to approximately 300 kPa. In contrast, the mechanical abrasion had a limited impact on lubricated surfaces, including on partial lubricated iPU. The ice adhesion strength only increased slightly from 20 kPa to 45 kPa on the iPU surface and from less than 1 kPa to about 10 kPa on the omni-PU surface, as shown in FIG. 9C. This also illustrates that ice adhesion strength on the lubricated surfaces is less impacted by the mechanical abrasion when compared to the changes in water contact angle hysteresis.

The present disclosure provides design principles and fabrication strategies to form a mechanical durable elastomeric coating, which integrates design principles for both mechanical durability (e.g., abrasion resistant parameter K_{AR}) and liquid repellency (e.g., Hansen solubility parameters), as well as solid repellency. In one variation, a hard polyurethane matrix and a stable full lubrication attached to the matrix enhance the abrasion resistance. The present disclosure also provides new polyol reactive infusion methods to fabricate robust omniphobic coatings, like an omniphobic polyurethane (omni-PU), which demonstrates ultra-low adhesion towards various liquid and solid foulants, spanning a broad range of elastic modulus (1 kPa to 1 GPa) and geometric dimensions (micrometers to meters) (FIG. 9D).

As a result of these combined properties, the liquid and solid repellant anti-fouling coatings are suitable for use in a variety of industrial and medical applications that are not possible using current conventional materials. For example, an omniphobic polyurethane can be used both as a surface coating and a self-cleaning material for bioimplants or biomedical robots, where both anti-biofouling and wear-resistance are necessary. For example, the reactive oil infusion methods may be used for other polymers that are biomedically acceptable for biomedical applications, for example, acrylate polymers, polyvinyl alcohol, polydimethylsiloxane, and the like. Therefore, this design and fabrication strategies for omni-PU can be translated to biocompatible materials for biomedical applications. First, the dimensionless abrasion resistance parameter K_{AR} described herein be used to design antifouling materials with strong mechanical durability by increasing hardness pₘ and lubrication r. Third, the Hansen solubility circles of various lubricants provide an accurate method to predict whether the liquid and solid repellant anti-fouling coatings can repel a targeted liquid foulant (e.g., crude oil and biological fluids), as well as identifying the appropriate choice of lubricants to be incorporated in the elastomeric layer that can repel the targeting liquid foulants. The liquid and solid repellant anti-fouling coatings provided by the present disclosure may be used in a variety of industrial and medical applications, including those in harsh working environments, such as underwater vehicles, airfoils, wind turbines, and cartilage implants, as well as anti-fouling wearable devices, biomedical implants, biomedical testing chips, controlled liquid-and-solid adhesion for soft robotics, non-stick coatings, engineering surfaces with enhanced resistance to organic solvents, finger-print resistant surfaces for flat panel displays, mobile devices, cell phones, sunglasses/safety glasses, oil pipelines, maritime vessels and equipment, limiting heat exchangers, and solar panels, by way of non-limiting example.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A durable solid and liquid repellant material comprising an elastomeric matrix having a plurality of lubricating domains distributed therein formed by a partial crosslinking reaction between an elastomeric precursor having a first reactive functional group and a polyol having a second reactive functional group, a dispersion (δD) solubility parameter of less than or equal to about 22 MPa^{1/2}, and a polar (δP) solubility parameter of less than or equal to about 20 MPa^{1/2}, wherein the first reactive functional group is selected from the group consisting of: alkene, amine, carboxylic acid, hydroxyl, isocyanate, and combinations thereof and the second reactive group is selected from the group consisting of: amine, carboxylic acid, hydroxyl group, and combinations thereof, wherein the elastomeric matrix has a crosslink density of greater than or equal to about 10 mol/m³ and less than or equal to about 2,000 mol/m³.

2. The durable solid and liquid repellant material of claim 1, wherein the elastomeric matrix has an elastic modulus (E) of less than or equal to about 1 GPa and a hardness of greater than or equal to about 30 Shore A hardness.

3. The durable solid and liquid repellant material of claim 1, wherein the hardness is greater than or equal to about 30 Shore A hardness to less than or equal to about 100 Shore A hardness.

4. The durable solid and liquid repellant material of claim 1, wherein the polyol is a compound that comprises at least two hydroxyl groups.

5. The durable solid and liquid repellant material of claim 1, wherein the elastomeric matrix comprises a polyurethane and the first reactive group comprises an isocyanate.

6. The durable solid and liquid repellant material of claim 5, wherein the elastomeric precursor comprises three isocyanate functional groups.

7. The durable solid and liquid repellant material of claim 5, wherein the elastomeric precursor comprises a triisocyanate aromatic polyurethane.

8. The durable solid and liquid repellant material of claim 1, wherein a weight ratio of the polyol to the elastomeric precursor is greater than or equal to about 0.5.

9. The durable solid and liquid repellant material of claim 1, wherein a weight ratio of the polyol to the elastomeric precursor is greater than or equal to about 0.75.

10. The durable solid and liquid repellant material of claim 1, wherein the durable solid and liquid repellant material further comprises a free polyol distributed therein.

11. The durable solid and liquid repellant material of claim 1, wherein the durable solid and liquid repellant material has an abrasion resistance parameter (K_{AR}) of greater than 1,000.

12. The durable solid and liquid repellant material of claim 1, wherein the durable solid and liquid repellant material has a transmissivity to wavelengths in the visible range of greater than or equal to about 90%.

13. The durable solid and liquid repellant material of claim 1, wherein the elastomeric precursor forms a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, and combinations thereof and the polyol is selected from the group consisting of: polyphenols, amino acids, hydroxyl- or amino-terminated polydimethylsiloxane, hydroxyl- or amino-terminated per-fluorinated polydimethylsiloxane, natural oils, and combinations thereof.

14. The durable solid and liquid repellant material of claim 1, wherein the elastomer precursor forms a polyurethane and the polyol comprises a hydroxyl-terminated polydimethylsiloxane diol.

15. The durable solid and liquid repellant material of claim 1, wherein the polyol has a molecular weight of greater than or equal to about 100 Da to less than or equal to about 10,000 Da.

16. The durable solid and liquid repellant material of claim 1, wherein after at least 500 abrasion cycles, the durable solid and liquid repellant material has a contact angle hysteresis of less than or equal to about 15° for water and for a predetermined oil.

17. A durable solid and liquid repellant material comprising an elastomeric matrix having a plurality of lubricating domains distributed therein formed by a partial crosslinking reaction between an elastomeric precursor having a first reactive functional group and a polyol, wherein the elastomeric precursor forms a polymer selected from the group consisting of: polyurethane, fluoropolyurethane, polybutadiene, cis-polyisoprene, cis-polybutadiene, polydimethylsiloxane, fluorosilicone, styrene-butadiene rubber, ethylene-propylene monomer, polyether block amides, and combinations thereof and the polyol is selected from the group consisting of: polyphenols, amino acids, hydroxyl- or amino-terminated polydimethylsiloxane, hydroxyl- or amino-terminated per-fluorinated polydimethylsiloxane, natural oils, and combinations thereof, the elastomeric matrix has a crosslink density of greater than or equal to about 10 mol/m³ and less than or equal to about 2,000 mol/m³, an elastic modulus (E) of less than or equal to about 1 GPa, and a hardness of greater than or equal to 30 Shore A hardness.

18. The durable solid and liquid repellant material of claim 17, wherein the polyol is selected from the group consisting of: catechin, hesperetin, cyanidin, quercetin, caffeic acid, catechol, gallic acid, tannic acid, epigallocatechin, epicatechin gallate, and epigallocatechin gallate, phenylalanine, valine, threonine, tryptophane, isoleucine, methionine, histidine, arginine, leucine, and lysine, hydroxyl- or amino-terminated polydimethylsiloxane, hydroxyl- or amino-terminated per-fluorinated polydimethylsiloxane coconut oil, essential oils, castor oil, sunflower seed oil, jojoba oil, grapeseed oil, and combinations thereof.

19. The durable solid and liquid repellant material of claim 17, wherein the polyol has a molecular weight of greater than or equal to about 100 Da to less than or equal to about 10,000 Da and the polyol is a compound that comprises at least two hydroxyl groups and the elastomeric precursor comprises three isocyanate functional groups the elastomeric precursor comprises three isocyanate functional groups.

20-28. (canceled)

29. The durable solid and liquid repellant material of claim 17, wherein the elastomer precursor forms a polyurethane and the polyol comprises a hydroxyl-terminated polydimethylsiloxane diol.

30-62. (canceled)
